(19) United States
(12) Patent Application Publication
(10) Pub. No.: US 2023/0209313 A1
(43) Pub. Date: Jun. 29, 2023

(54) WIRELESS COMMUNICATION METHOD AND USER EQUIPMENT FOR UL FEEDBACK

(71) Applicant: FG Innovation Company Limited, Tuen Mun (HK)

(72) Inventors: HENG-LI CHIN, Taipei (TW); CHIA-HUNG LIN, Taipei (TW); HUNG-CHEN CHEN, Taipei (TW); YUNG-LAN TSENG, Taipei (TW)

(21) Appl. No.: 17/927,729

(22) PCT Filed: May 26, 2021
(86) PCT No.: PCT/CN2021/096108

§ 371 Date: Nov. 24, 2022

Related U.S. Application Data
(60) Provisional application No. 63/031,512, filed on May 28, 2020.

(51) Int. Cl. H04W 4/06; H04W 72/23; H04W 72/0453; H04L 1/1812

(52) U.S. Cl. CPC H04W 4/06; H04W 72/23; H04W 72/0453; H04L 1/1812

(57) ABSTRACT

A wireless communication method performed by a User Equipment (UE) for providing uplink (UL) feedback in response to receiving data corresponding to a Multicast Broadcast Service (MBS) is presented. The wireless communication method includes receiving the data corresponding to the MBS; and enabling a transmission of the UL feedback in response to receiving the data corresponding to the MBS if at least one of a plurality of predetermined conditions is satisfied. The plurality of predetermined conditions includes receiving an indication to enable the UL feedback in response to receiving the data corresponding to the MBS and receiving an indication of a UL resource for transmitting the UL feedback.

### CROSS-REFERENCE TO RELATED APPLICATION(S)

The present disclosure is a National Stage application of International Patent Application Serial No. PCT/CN2021/096108, filed on May 26, 2021, which claims the benefit of and priority to U.S. Provisional Patent Application Ser. No. 63/031,512, filed on May 28, 2020, and entitled “METHOD AND APPARATUS TO SUPPORT UPLINK FEEDBACK FOR MULTIMEDIA BROADCAST MULTICAST SERVICE”. The contents of the above-referenced applications are hereby incorporated herein fully by reference for all purposes.

### FIELD

The present disclosure is generally related to wireless communications and, more specifically, to a wireless communication method and a user equipment for providing uplink (UL) feedback in response to receiving Multicast Broadcast Service (MBS) data.

### BACKGROUND

With the tremendous growth in the number of connected devices and the rapid increase in user/Network (NW) traffic volume, various efforts have been made to improve different aspects of wireless communication for the next-generation wireless communication system, such as the fifth-generation (5G) New Radio (NR) system, by improving data rate, latency, reliability, and mobility.

The 5G NR system is designed to provide flexibility and configurability to optimize the NW services and types, accommodating various use cases such as Enhanced Mobile Broadband (eMBB), Massive Machine-Type Communication (mMTC), and Ultra-Reliable and Low-Latency Communication (URLLC).

However, as the demand for radio access continues to increase, there is a need in the art to improve uplink (UL) feedback in response to receiving Multicast Broadcast Service (MBS) data.

### SUMMARY

The present disclosure is directed to a wireless communication method and user equipment (UE) for providing uplink (UL) feedback in response to receiving Multicast Broadcast Service (MBS) data.

According to an aspect of the present disclosure, a wireless communication method performed by a User Equipment (UE) for providing uplink (UL) feedback in response to receiving data corresponding to a Multicast Broadcast Service (MBS) is provided. The wireless communication method includes receiving the data corresponding to the MBS; and enabling a transmission of the UL feedback in response to receiving the data corresponding to the MBS if at least one of a plurality of predetermined conditions is satisfied. The plurality of predetermined conditions includes receiving an indication to enable the UL feedback in response to receiving the data corresponding to the MBS; and receiving an indication of a UL resource for transmitting the UL feedback.

According to another aspect of the present disclosure, a User Equipment (UE) in a wireless communication system for providing uplink (UL) feedback in response to receiving data corresponding to a Multicast Broadcast Service (MBS) is provided. The UE includes at least one processor; and at least one memory coupled to the at least one processor, wherein the at least one memory stores computer-executable instructions that, when executed by the at least one processor, cause the UE to receive the data corresponding to the MBS; and enable a transmission of the UL feedback in response to receiving the data corresponding to the MBS if at least one of a plurality of predetermined conditions is satisfied. The plurality of predetermined conditions includes receiving an indication to enable the UL feedback in response to receiving the data corresponding to the MBS; and receiving an indication of a UL resource for transmitting the UL feedback.

### BRIEF DESCRIPTION OF THE DRAWINGS

Aspects of the present disclosure are best understood from the following when read with the accompanying figures. Various features are not drawn to scale. Dimensions of various features may be arbitrarily increased or reduced for clarity of discussion.

FIG. 1 is a flowchart illustrating a procedure performed by a UE for providing UL feedback in response to receiving data corresponding to an MBS, according to an example implementation of the present disclosure.

FIG. 2 illustrates a block diagram of a node for wireless communication, according to an example implementation of the present disclosure.

### DESCRIPTION

The acronyms in the present disclosure are defined as follows. Unless otherwise specified, the acronyms have the following meanings.

| Acronym | Full name |
|---|---|
| 3GPP | 3^{rd} Generation Partnership Project |
| 5G | 5th generation |
| ACK | Acknowledgment |
| ARQ | Automatic Repeat Request |
| BCH | Broadcast Channel |
| BCCH | Broadcast Control Channel |
| BL | Bandwidth reduced Low complexity |
| BFR | Beam Failure Recovery |
| BS | Base Station |
| BSR | Buffer Status Report |
| BWP | Bandwidth Part |
| CA | Carrier Aggregation |
| CB | Contention-Based |
| CC | Component Carriers |
| CCCH | Common Control Channel |
| CE | Control Element |
| CF | Contention-Free |
| CG | Cell Group |
| CN | Core Network |
| CORESET | Control Resource Set |
| C-RNTI | Cell Radio Network Temporary Identifier |
| CRC | Cyclic Redundancy Check |
| DCI | Downlink Control Information |
| DL | Downlink |
| DL-SCH | Downlink-Shared Channel |
| DRB | Data Radio Bearer |
| E-UTRA | Evolved Universal Terrestrial Radio Access |
| E-UTRAN | Evolved Universal Terrestrial Radio Access Network |
| G-RNTI | Group Radio Network Temporary Identifier |
| HARQ | Hybrid Automatic Repeat Request |
| HO | Handover |
| ID | Identification |
| IE | Information Element |
| L1 | Layer 1 |
| L2 | Layer 2 |
| LCID | Logical Channel Identity |
| LCG | Logical Channel Group |
| LCH | Logical Channel |
| LTE | Long-Term Evolution |
| MAC | Medium Access Control |
| MBMS | Multimedia Broadcast Multicast Service |
| MBSFN | Multicast Broadcast Single Frequency Network |
| MCE | Multi-cell/multicast Coordination Entity |
| MCG | Master Cell Group |
| MCH | Multicast Channel |
| MCCH | Multicast Control Channel |
| MCS | Modulation and Coding Scheme |
| MTCH | Multicast Traffic Channel |
| MIMO | Multi-input Multi-output |
| MSG | Message |
| NACK | Non-Acknowledgment |
| NAS | Non-Access Stratum |
| NB-IoT | Narrow Band Internet of Things |
| NDI | New Data Indicator |
| NR | New RAT/Radio |
| NUL | Normal Uplink |
| NW | Network |
| OFDM | Orthogonal Frequency Division Multiplexing |
| PCell | Primary Cell |
| PDCCH | Physical Downlink Control Channel |
| PDCP | Packet Data Convergence Protocol |
| PDSCH | Physical Downlink Shared Channel |
| PDU | Protocol Data Unit |
| PHY | Physical Layer |
| PMCH | Physical Multicast Channel |
| PSCell | Primary SCell |
| PTAG | Primary Timing Advance Group |
| PRB | Physical Resource Block |
| PUCCH | Physical Uplink Control Channel |
| PUSCH | Physical Uplink Shared Channel |
| RA | Random Access |
| RAN | Radio Access Network |
| RAT | Radio Access Technologies |
| Rel | Release |
| RLC | Radio Link Control |
| RUF | Radio Link Failure |
| RNTI | Radio Network Temporary Identifier |
| RRC | Radio Resource Control |
| SCell | Secondary Cell |
| SCG | Secondary Cell Group |
| SC-MCCH | Single Cell Multicast Control Channel |
| SC-MTCH | Single Cell Multicast Traffic Channel |
| SC-N-RNTI | Single Cell Notification Radio Network |
| | Temporary Identifier |
| SC-PTM | Single Cell Point to Multipoint |
| SC-RNTI | Single Cell Radio Network Temporary Identifier |
| SDAP | Service Data Adaptation Protocol |
| SDU | Service Data Unit |
| SFN | System Frame Number |
| SI | System Information |
| SIB | System Information Block |
| SR | Scheduling Request |
| SRB | Signaling Radio Bearer |
| SSB | Synchronization Signal Block |
| SpCell | Special Cell |
| SPS | Semi-Persistent Scheduling |
| SUL | Supplementary Uplink |
| TA | Timing Advance |
| TAG | Timing Advance Group |
| TB | Transport Block |
| TMGI | Temporary Mobile Group Identity |
| TR | Technical Report |
| TRP | Transmission/Reception Point |
| TS | Technical Specification |
| UE | User Equipment |
| UL | Uplink |
| UM | Unacknowledged mode |
| UL-SCH | Uplink Shared Channel |

The following contains specific information pertaining to implementations of the present disclosure. The drawings and their accompanying detailed disclosure are directed to merely exemplary implementations. However, the present disclosure is not limited to these exemplary implementations. Other variations and implementations of the present disclosure will occur to those skilled in the art. Unless noted otherwise, like or corresponding elements among the figures may be indicated by like or corresponding reference numerals. Moreover, the drawings and illustrations in the present disclosure are generally not to scale and are not intended to correspond to actual relative dimensions.

For consistency and ease of understanding, like features are identified (although, in some examples, not illustrated) by numerals in the example figures. However, the features in different implementations may differ in other respects, and thus shall not be narrowly confined to what is illustrated in the figures.

References to “one implementation,” “an implementation,” “example implementation,” “various implementations,” “some implementations,” “implementations of the present disclosure,” etc., may indicate that the implementation(s) of the present disclosure may include a particular feature, structure, or characteristic, but not every possible implementation of the present disclosure necessarily includes the particular feature, structure, or characteristic. Further, repeated use of the phrase “in one implementation,” “in an example implementation,” or “an implementation,” do not necessarily refer to the same implementation, although they may. Moreover, any use of phrases like “implementations” in connection with “the present disclosure” are not meant to characterize that all implementations of the present disclosure must include the particular feature, structure, or characteristic, and should instead be understood to mean “at least some implementations of the present disclosure” includes the stated particular feature, structure, or characteristic.

The term “coupled” is defined as connected, whether directly or indirectly through intervening components, and is not necessarily limited to physical connections. The term “comprising,” when utilized, means “including, but not necessarily limited to”; it specifically indicates open-ended inclusion or membership in the so-disclosed combination, group, series, and the equivalent.

The term “and/or” is only an association relationship for describing associated objects, and represents that three relationships may exist; for example, A and/or B may represent that: A exists alone, A and B exist at the same time, and B exists alone. “A and/or B and/or C” may represent that at least one of A, B and C exists. In addition, the character “/” generally represents that the former and latter associated objects are in an “or” relationship.

Additionally, for the purpose of non-limiting explanation, specific details, such as functional entities, techniques, protocols, standards, and the like, are set forth for providing an understanding of the disclosed technology. In other examples, a detailed disclosure of well-known methods, technologies, systems, architectures, and the like are omitted in order not to obscure the present disclosure with unnecessary details.

Persons skilled in the art will immediately recognize that any NW function(s) or algorithm(s) in the present disclosure may be implemented by hardware, software, or a combination of software and hardware. Disclosed functions may correspond to modules that may be software, hardware, firmware, or any combination thereof. The software implementation may include computer-executable instructions stored on computer-readable media, such as memory or other types of storage devices.

For example, one or more microprocessors or general-purpose computers with communication processing capability may be programmed with corresponding executable instructions and carry out the disclosed NW function(s) or algorithm(s). The microprocessors or general-purpose computers may be formed of Application-Specific Integrated Circuits (ASICs), programmable logic arrays, and/or one or more Digital Signal Processor (DSPs). Although some of the example implementations in the present disclosure are directed to software installed and executing on computer hardware, alternative example implementations implemented as firmware, hardware, or a combination of hardware and software are well within the scope of the present disclosure.

The computer-readable medium includes but is not limited to Random Access Memory (RAM), Read-Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication NW architecture (e.g., a LTE system, an LTE-Advanced (LTE-A) system, or an LTE-Advanced Pro system) typically includes at least one BS, at least one UE, and one or more optional NW elements that provide connection towards an NW. The UE communicates with the NW (e.g., a CN, an Evolved Packet Core (EPC) NW, an E-UTRAN, a Next-Generation Core (NGC), a 5G Core NW (5GC), or an Internet), through a RAN established by the BS.

It should be noted that, in the present disclosure, a UE may include, but is not limited to, a mobile station, a mobile terminal or device, or a user communication radio terminal. For example, a UE may be a portable radio equipment, which includes, but is not limited to, a mobile phone, a tablet, a wearable device, a sensor, or a Personal Digital Assistant (PDA) with wireless communication capability. The UE is configured to receive and transmit signals over an air interface to one or more cells in a RAN.

A BS may include, but not limited to, a Node B (NB) as in the Universal Mobile Telecommunication System (UMTS), an evolved Node B (eNB) as in the LTE-A, a Radio NW Controller (RNC) as in the UNITS, a Base Station Controller (BSC) as in the Global System for Mobile communications (GSM)/GSM EDGE Radio Access NW (GERAN), a Next Generation eNB (ng-eNB) as in an E-UTRA BS in connection with the 5GC, a gNB as in the 5G Access NW (5G-AN), and any other apparatus capable of controlling radio communication and managing radio resources within a cell. The BS may connect to serve the one or more UEs through a radio interface to the NW.

A BS may be configured to provide communication services according to at least one of the following Radio Access Technologies (RATs): Worldwide Interoperability for Microwave Access (WiMAX), GSM (often referred to as 2G), GERAN, General Packet Radio Service (GPRS), UNITS (often referred to as 3G) based on basic Wideband-Code Division Multiple Access (W-CDMA), High-Speed Packet Access (HSPA), LTE, LTE-A, enhanced L (eLTE), NR (often referred to as 5G), and LTE-A Pro. However, the scope of the present disclosure should not be limited to the protocols previously disclosed.

The BS may be operable to provide radio coverage to a specific geographical area using a plurality of cells included in the RAN. The BS may support the operations of the cells. Each cell is operable to provide services to at least one UE within its radio coverage. More specifically, each cell (often referred to as a serving cell) may provide services to serve one or more UEs within its radio coverage (e.g., each cell schedules the DL and optionally UL resources to at least one UE within its radio coverage for DL and optionally UL packet transmissions). The BS may communicate with one or more UEs in the radio communication system through the plurality of cells. A cell may allocate sidelink (SL) resources for supporting proximity service (ProSe). Each cell may have overlapped coverage areas with other cells.

In Multi-RAT Dual Connectivity (MR-DC) cases, the primary cell of an MCG or an SCG may be called a SpCell. A PCell may refer to the SpCell of an MCG. A PSCell may refer to the SpCell of an SCG. MCG refers to a group of serving cells associated with the Master Node (MN), including the SpCell and optionally one or more SCells. SCG refers to a group of serving cells associated with the Secondary Node (SN), including the SpCell and optionally one or more SCells.

In some implementations, the UE may not have (LTE/NR) RRC connections with the concerned serving cells of the associated services. In other words, the UE may not have UE-specific RRC signaling exchange with the serving cell. Instead, the UE may only monitor the DL synchronization signals (e.g., DL synchronization burst sets) and/or broadcasting SI related to the concerned services from such serving cells. In addition, the UE may have at least one serving cell on one or more target SL frequency carriers for the associated services. In some other implementations, the UE may consider the RAN which configures one or more of the serving cells as a serving RAN.

As previously disclosed, the frame structure for NR supports flexible configurations for accommodating various next-generation (e.g., 5G) communication requirements, such as eMBB, mMTC, and URLLC, while fulfilling high reliability, high data rate, and low latency requirements. The OFDM technology, as disclosed in 3GPP, may serve as a baseline for an NR waveform. The scalable OFDM numerology, such as the adaptive sub-carrier spacing, the channel bandwidth, and the cyclic prefix (CP), may also be used. Additionally, two coding schemes are considered for NR: (1) low-density parity-check (LDPC) code and (2) polar code. The coding scheme adaptation may be configured based on the channel conditions and/or service applications.

It is also considered that in a transmission time interval of a single NR frame, at least DL transmission data, a guard period, and UL transmission data should be included. The respective portions of the DL transmission data, the guard period, and the UL transmission data should also be configurable, for example, based on the NW dynamics of NR. In addition, SL resources may also be provided in an NR frame to support ProSe services.

In some implementations, the following descriptions may be used to elaborate the term, example, embodiment, action, behavior, alternative, aspect, or claim mentioned in the following:
The UL grant may be used to indicate a PUSCH resource.
The PUSCH resource may also be referred to as a UL-SCH resource.
The UE may be referred to as a PHY/MAC/RLC/PDCP/SDAP/RRC entity. Alternatively, the PHY/MAC/RLC/PDCP/SDAP/RRC entity may also be referred to as the UE.
The NW may be a network node, a TRP, a cell (e.g., SpCell, PCell, PSCell, and/or SCell), a eNB, a gNB, and/or a base station.
The Serving Cell may be a PCell, a PSCell, or an SCell. Also, the serving cell may be an activated or a deactivated serving cell.
For Dual Connectivity operation, the SpCell may refer to the PCell of the MCG or the PS Cell of the SCG depending on if the MAC entity is associated to the MCG or the SCG, respectively; alternatively, the SpCell may refer to the PCell. Also, a Special Cell supports PUCCH transmission and contention-based RA, and is always activated.
In the case of Dual Connectivity or Multi-RAT Connectivity (MR-DC), a broadcast/multicast service may be supported by both the Master Node and the Secondary Node. Moreover, the configuration related to the broadcast/multicast service may be delivered through SRB1 or SRB3.
The embodiments, implantations, examples, cases, and alternatives introduced below may be applied in both LTE and NR.
In the case of Dual Connectivity, the proposed counter and/or timer (e.g., MBMS_timer and Consecutive_failure_timer) may be reset with the change of Master Node or Secondary Node.
The CC may be PCell, PSCell, and/or SCell.
Broadcast/multicast HARQ process: This is allocated to DL resources that may be specifically used for transmission of broadcast/multicast services. Specifically, the broadcast/multicast HARQ process may be used for identifying a DL resource (for transmitting a TB/MAC PDU). Moreover, the DL resource may map to a broadcast/multicast DL Transport channel (e.g., BCH, MCH) and/or broadcast/multicast DL LCH (e.g., MTCH, MCCH, BCCH, SC-MTCH, SC-MCCH).
A TB may be referred to as a MAC PDU.
The Soft buffer may correspond to a DL (broadcast/multicast) HARQ process.
It is noted that the configurations in the UL BWP (e.g., configuration of UL resource for transmission of control or data traffic) may be applied to both NUL and SUL.

In some implementations, the LTE MBMS aims to provide an efficient mode of delivery of both broadcast and multicast services over the CN. Typically, the broadcast service is provided via a DL-only point-to-multipoint transmission from the NW to multiple UEs; the content is transmitted once to all UEs in a geographical area, and users are free to choose whether or not to receive the content. On the other hand, the multicast service is provided via a DL-only point-to-multipoint transmission from the NW to a managed group of UEs; the content is transmitted once to the whole group, and only the users belonging to the managed group can receive the content.

As introduced in 3GPP TS 36.300 V16.0.0 for E-UTRA and E-UTRAN, a UE may receive MBMS (from the NW) in an RRC_IDLE state. Alternatively, a UE may receive MBMS (from the NW) in an RRC_CONNECTED state if the UE is not an NB-IoT UE, BL UE or UE in enhanced coverage.

In some implementations, transmission of an MBMS in E-UTRAN uses either MBSFN transmission or SC-PTM transmission. The MCE makes the decision on whether to use SC-PTM or MBSFN for each MBMS session.

MBMS Transmitted Using MBSFN Transmission

In some implementations, MBMS transmitted using MBSFN transmission has the following characteristics:
Synchronous transmission of MBMS within its MBSFN Area. In one implementation, a geographical area of the NW where MBMS may be transmitted is called an MBMS Service Area. In another implementation, a geographical area where all eNBs may be synchronized and may perform MBSFN transmissions is called an MBSFN Synchronization Area. In another implementation, all eNBs in a given MBSFN Synchronization Area have a synchronized radio frame timing such that the radio frames are transmitted at the same time and have the same SFN. In another implementation, the area within an MBSFN Synchronization Area, covered by a group of cells participating in an MBSFN transmission, is called an MBSFN Area. An MBSFN Synchronization Area may support several MBSFN Areas. Moreover, a cell within an MBSFN Synchronization Area may form part of multiple MBSFN Areas, and each of the multiple MBSFN Areas is characterized by different (MBMS) transmitted content and a different set of participating cells.
Combining of MBMS transmission from multiple cells is supported.
Scheduling of each MCH is done by the MCE. In one implementation, all eNBs have the same configuration of RLC/MAC/PHY for each MBMS service, and identical information (e.g. time information, transmission order/priority information), such that synchronized MCH scheduling in the eNBs is ensured. These are indicated in advance by the MCE. In another implementation, the MCH is mapped to PMCH. In another implementation, the SIB2 defines the subframes that include resources for the MBSFN transmission in DL (e.g., an MBSFN subframe). In one example, an MBSFN subframe is the subframe that includes the PMCH resource. In another implementation, the MBSFN subframes indicated by SIB2 may be used by all MBSFN areas. In another implementation, in an MBSFN subframe (e.g., a subframe that includes resources for MBSFN transmissions), the MCH uses all the resources in the frequency domain, such that MCH-related scheduling may be only related to the subframe allocation in the time domain. In another implementation, the MBMS may not use the PDCCH for dynamic scheduling.
MTCH and MCCH may be multiplexed on the same MCH and mapped on MCH for point-to-multipoint transmission.
A single Transport Block is used per Transmission Time Interval (TTI) for MCH transmission, and TB uses all the MBSFN resources in that subframe.
A single transmission is used for MCH. In one implementation, neither blind HARQ repetitions nor RLC quick repeat is supported (for transmission on MCH).
MTCH and MCCH use the RLC-UM mode.
The MAC subheader indicates the LCID for MTCH and MCCH.

In some implementations, multiple MBMS services may be mapped to the same MCH and one MCH contains data belonging to only one MBSFN Area. An MBSFN Area contains one or more MCHs. An MCH-specific MCS is used for all subframes of the MCH that do not use the MCS indicated in BCCH. All MCHs have the same coverage area.

In some implementations, for MCCH and MTCH, the UE may not perform RLC re-establishment at cell change between cells of the same MBSFN area. Within the MBSFN subframes, all MCHs within the same MBSFN area occupy a pattern of subframes, not necessarily adjacent in time, that is common for all these MCHs and is therefore called the Common Subframe Allocation (CSA) Pattern. The CSA pattern is periodically repeated with the CSA period. The actual MCH subframe allocation (MSA) for every MCH carrying MTCH is defined by the CSA pattern, the CSA period, and the MSA end, that are all signaled on MCCH. The MSA end indicates the last subframe of the MCH within the CSA period. The MCHs are time multiplexed within the CSA period, which finally defines the interleaving degree between the MCHs. It may be possible for MCHs to not use all MBSFN resources signaled as part of the Rel-8 MBSFN signaling. Such MBSFN resource may be shared for more than one purpose (MBMS, Positioning, etc.). During one MCH scheduling period (MSP), which is configurable per MCH, the eNB applies MAC multiplexing of different MTCHs and optionally MCCH to be transmitted on this MCH.

Specifically, MCH scheduling information (MSI) is provided per MCH to indicate which subframes are used by each MTCH during the MSP, and to indicate whether transmission for an MTCH is going to be, or has been, suspended by the eNB. The following principles are used for the MSI:
It is used both when services are multiplexed onto the MCH and when only a single service is transmitted on the MCH.
It is generated by the eNB and provided once at the beginning of the MSP.
It has higher scheduling priority than the MCCH and, when needed, it appears first in the PDU.
It allows the receiver to determine what subframes are used by every MTCH, sessions are scheduled in the order in which they are included in the MCCH session list.
It is carried in a MAC CE which may not be segmented.
It carries the mapping of MTCHs to the subframes of the associated MSP. This mapping is based on the indexing of subframes belonging to one MSP.
It carries an indication of whether the transmission of an MTCH is to be suspended by the eNB.

MBMS Transmitted Using SC-PTM Transmission

As introduced in 3GPP TS 36.300 V16.0.0 for E-UTRA and E-UTRAN, the MBMS transmitted using SC-PTM transmission has the following characteristics:
MBMS is transmitted in the coverage of a single cell.
One SC-MCCH and one or more SC-MTCH(s) are mapped on DL-SCH. In one implementation, the DL-SCH is mapped to PDSCH. In another implementation, the SC-MCCH is a point-to-multipoint DL channel used for transmitting MBMS control information (e.g., SCPTMConfiguration message as introduced in 3GPP TS 36.331 V16.0.0 for E-UTRA) from the NW to the UE for one or several SC-MTCHs. This channel is only used by UEs that receive or are interested to receive MBMS using SC-PTM. In another implementation, the SC-MTCH is a point-to-multipoint DL channel used for transmitting traffic data from the NW to the UE using SC-PTM transmission. This channel is only used by UEs that receive MBMS using SC-PTM.
Scheduling is done by the eNB.
SC-MCCH and SC-MTCH transmissions (e.g., PDSCH used for transmission of SC-MCCH information and PDSCH used for transmission of SC-MTCH information) are each scheduled/indicated by a logical-channel-specific RNTI on PDCCH. For example, there is a one-to-one mapping between TMGI and G-RNTI used for the reception of the DL-SCH to which a SC-MTCH is mapped. In one implementation, the PDCCH (DCI) associated (e.g., CRC scrambled) with SC-RNTI may be used to indicate the transmission of SC-MCCH (e.g., the PDSCH on which SC-MCCH is mapped). In another implementation, the PDCCH (DCI) associated (e.g., CRC scrambled) with G-RNTI may be used to indicate the transmission of an SC-MTCH (e.g., the PDSCH on which SC-MTCH is mapped). In another implementation, the value of SC-RNTI is written, as introduced in 3GPP TS 38.321 V16.0.0, with a value of FFFB. In another implementation, the value of a G-RNTI and a (1-to-1) mapping between the G-RNTI and its respective TMGI/MBMS session is indicated via SCPTMConfiguration message, as introduced in 3GPP TS 36.33 1 V16.0.0, (e.g., SC-MCCH). A single SCPTMConfiguration message may indicate a list of one or multiple G-RNTIs and their respective TMGIs/MBMS sessions.
A single transmission is used for DL-SCH (e.g., neither blind HARQ repetitions nor RLC quick repeat) on which SC-MCCH or SC-MTCH is mapped.
SC-MCCH and SC-MTCH use the RLC-UM.

MBMS Signaling on BCCH (e.g., SIB)

In some implementations, the BCCH only points to the resources where the MCCH(s)/SC-MCCH may be found (e.g., the BCCH does not indicate the availability of the services).

In one implementation, for each MCCH, the BCCH independently indicates the following:
the scheduling of the MCCH for multi-cell transmission on MCH.
the MCCH modification period, repetition period radio frame offset and subframe allocation.
an MCS which applies to the subframes indicated for MCCH scheduling and for the first subframe of all MSPs in that MBSFN Area.

In another implementation, for the notification commonly used for all MCCH, the BCCH may be configured to:
configure the position of the MCCH change notification subframe and the number of occasions monitored by the UE.
indicate the mapping between the PDCCH bit(s) carried in the notification and the MCCH(s).

In another implementation, the BCCH indicates the SC-MCCH modification period, SC-MCCH repetition period, and SC-MCCH subframe offset.

MCCH Information Validity and Notification of Changes

In some implementations, the change of MCCH information only occurs at specific radio frames (e.g., when the concept of a modification period is used). Within a modification period, the same MCCH information may be transmitted a number of times, as defined by its scheduling (which is based on a repetition period). The modification period boundaries are defined by SFN values for which SFN mod m=0, where m is the number of radio frames comprising the modification period. In one example, the modification period is configured by means of SystemInformationBlockType13.

In some implementations, when the NW changes (some of) the MCCH information, the NW notifies the UEs about the change during a first modification period. In the next modification period, the NW transmits the updated MCCH information. Upon receiving a change notification, a UE interested to receive MBMS services acquires the new MCCH information immediately from the start of the next modification period. The UE applies the previously acquired MCCH information until the UE acquires the new MCCH information.

In some implementations, indication of an MBMS-specific RNTI, e.g., the M-RNTI, on PDCCH is used to inform UEs in the RRC_IDLE and UEs in the RRC_CONNECTED about an MCCH information change. When receiving an MCCH information change notification, the UE knows that the MCCH information will change at the next modification period boundary. The notification on PDCCH indicates which of the MCCHs will change, which is done by means of an 8-bit bitmap. Within this bitmap, the bit at the position indicated by the field notificationIndicator is used to indicate changes for that MBSFN area. If the bit is set to “1”, the corresponding MCCH may change. The MCCH information change notification is used to inform the UE about a change of MCCH information upon session start or about the start of MBMS counting.

SC-MCCH Information Validity and Notification of Changes

In some implementations, the change of SC-MCCH information only occurs at specific radio frames (e.g., when the concept of a modification period is used). Within a modification period, the same SC-MCCH information may be transmitted a number of times, as defined by its scheduling (which is based on a repetition period). The modification period boundaries are defined by SFN values for which SFN mod m=0, where m is the number of radio frames comprising the modification period. The modification period is configured by means of SystemInformationBlockType20.

In some implementations, when the NW changes (some of) the SC-MCCH information, the NW notifies the UEs, other than BL UEs, UEs in CE, or NB-IoT UEs, about the change in the first subframe which may be used for SC-MCCH transmission in a repetition period. LSB bit in 8-bit bitmap when set to ‘1’ indicates the change in SC-MCCH. Upon receiving a change notification, a UE interested to receive MBMS services transmitted using SC-PTM acquires the new SC-MCCH information starting from the same subframe. The UE applies the previously acquired SC-MCCH information until the UE acquires the new SC-MCCH information.

In some implementations, when the NW changes (some of) the SC-MCCH information for start of new MBMS service(s) transmitted using SC-PTM, the NW notifies BL UEs, UEs in CE, or NB-IoT UEs about the change in every PDCCH which schedules the first SC-MCCH in a repetition period in the current modification period. The notification is transmitted with 1 bit. The bit, when set to ‘1’, indicates the start of new MBMS service(s). Upon receiving a change notification, a BL UE, UE in CE, or NB-IoT UE interested to receive MBMS services transmitted using SC-PTM acquires the new SC-MCCH information scheduled by the PDCCH. The BL UE, UE in CE, or NB-IoT UE applies the previously acquired SC-MCCH information until the BL UE, UE in CE, or NB-IoT UE acquires the new SC-MCCH information.

As specified through the above background information, it is introduced to disclose the (DL) Broadcast/multicast services as defined in NR Rel-17. One of the key aspects to consider is the reliability of (DL) broadcast/multicast services. This may be achieved by UL feedback upon reception of (DL) broadcast/multicast services from the NW. The existing NR L1 feedback mechanism (e.g., HARQ feedback) or NR L2/L3 feedback mechanism (e.g., reporting a specific MAC CE and/or a specific RRC message upon reception of (DL) broadcast/multicast service) may be taken as the baseline when designing a UL feedback mechanism for (DL) broadcast/multicast services in NR.

MAC-Based/RRC-Based/ACK-NACK UL Feedback

Conditions to Trigger (and Report) a Broadcast/Multicast MAC CE and/or Report a Broadcast/Multicast RRC Message

It is introduced that a MAC-based/RRC-based UL feedback mechanism may be supported for NR broadcast/multicast service.

In one embodiment, a broadcast/multicast MAC CE may be triggered by a UE and/or a broadcast/multicast RRC message may be reported by a UE when one or multiple conditions out of condition 1 to condition 10 have been satisfied. In one case, if one or multiple broadcast/multicast MAC CEs have been triggered, a broadcast/multicast MAC CE may be reported (by the UE) when a UL resource becomes available for transmission of this MAC CE. In another case, if one or multiple of conditions out of condition 1 to condition 10 have been satisfied, the UE (e.g., RRC layer) may initiate transmission of a broadcast/multicast RRC message. In another case, a HARQ ACK-NACK may be reported by a UE when one or multiple conditions out of condition 1 to condition 10 have been satisfied.

In one alternative, the broadcast/multicast MAC CE and/or the broadcast/multicast RRC message may be used to explicitly/implicitly indicate whether a specific broadcast/multicast service has been received (in response to the broadcast/multicast service in the DL).

In another alternative, the broadcast/multicast MAC CE and/or the broadcast/multicast RRC message may be UE assistance information, which indicates the preferred broadcast/multicast service that a UE may receive.

Condition 1: The UE receives a broadcast/multicast service with specific characteristic(s).

Specifically, the received broadcast/multicast service may correspond to a specific broadcast/multicast service ID. In one implementation, a specific broadcast/multicast ID may be referred to as a specific broadcast/multicast session ID (e.g., an ID that identifies a broadcast/multicast session), mobile group identity (e.g., TMGI), etc.

In one example, a UE may trigger a broadcast/multicast MAC CE and/or report a broadcast/multicast RRC message when the UE receives (the data of) a broadcast/multicast service, which is associated with a specific broadcast/multicast service ID. In another example, a UE may report a HARQ ACK/NACK when the UE receives (the data of) a broadcast/multicast service, which is associated with a specific broadcast/multicast service ID. Moreover, the broadcast/multicast MAC CE may be considered as being triggered by the broadcast/multicast service with a specific broadcast/multicast service ID.

Specifically, the broadcast/multicast service may be received from a specific (DL) BWP/Cell/frequency range. In one implementation, a specific (DL) BWP/Cell may be a (DL) BWP/Cell with a specific (DL) BWP/Cell ID. In another implementation, a specific (DL) BWP/Cell may be a (DL) BWP/Cell that has been explicitly indicated by the NW via dedicated signaling (e.g., via a bit indication in the BWP-Downlink IE or via a bit indication in the ServingCellConfig IE, as introduced in 3 GPP TS 38.331 V16.0.0) or broadcast SI.

In one implementation, a specific (DL) BWP/Cell may be written in specification (e.g., preconfigured). In one example, the NW may provide different broadcast/multicast services in different (DL) BWPs. This may be done by providing a UE a mapping table which maps different broadcast/multicast services to different (DL) BWPs and/or Cells. Hence, the UE may be switched (or initiates BWP switching itself) between different (DL) BWPs in order to receive different broadcast/multicast services. Subsequently, the UE may trigger a broadcast/multicast MAC CE and/or report a broadcast/multicast RRC message if the UE receives (the data of) a broadcast/multicast service (e.g., DL data corresponding to the broadcast/multicast service) at a specific (DL) BWP and/or a specific cell. Moreover, the broadcast/multicast MAC CE may be considered as being triggered by the broadcast/multicast service at a specific (DL) BWP and/or the specific cell.

In another implementation, the UE may trigger a broadcast/multicast MAC CE and/or report a broadcast/multicast RRC message if the UE may receive (the data of) a broadcast/multicast service (e.g., DL data corresponding to the broadcast/multicast service) at a specific (DL) BWP and/or a specific cell. After (successfully) transmitting the broadcast/multicast MAC CE and/or report a broadcast/multicast RRC message, the UE may autonomously switch to the specific (DL) BWP and/or the specific cell to receive (the data of) the broadcast/multicast service, which may be indicated by the broadcast/multicast MAC CE and/or broadcast/multicast RRC message.

Specifically, the received broadcast/multicast service may correspond to a specific LCH. In one implementation, a specific LCH may be an LCH used for transmission of control signaling related to broadcast/multicast services in a single cell (e.g., SC-MCCH) or across multiple cells (e.g., MCCH). In another implementation, a specific LCH may be an LCH used for transmission of data traffic related to broadcast/multicast services in a single cell (e.g., SC-MTCH) or across multiple cells (e.g., MTCH). In one implementation, (DL) MAC SDU from a specific LCH may have a specific LCID value. In one example, a UE may trigger a broadcast/multicast MAC CE and/or report a broadcast/multicast RRC message if the UE receives (the data of) a broadcast/multicast service from a specific LCH. Moreover, the broadcast/multicast MAC CE may be considered as being triggered by the broadcast/multicast service from a specific LCH.

In another implementation, lower layers (e.g., MAC layer) of a UE may receive the information from upper layers (e.g., RRC layer or NAS layer) of the UE about the intention to receive (the data of) a broadcast/multicast service. In one example, the MAC layer of a UE may receive the information from upper layers (e.g., RRC layer or NAS layer or application layer) of the UE about the intention to receive (the data of) a broadcast/multicast service. Subsequently, the MAC layer of the UE may trigger a broadcast/multicast MAC CE.

Specifically, the broadcast/multicast service may be scheduled by a DCI associated with a specific RNTI. In one implementation, a specific RNTI may correspond to a specific RNTI value as written in specification (e.g., preconfigured). In one implementation, a specific RNTI may be used for scheduling of a DL physical channel for transmission of (DL) control signaling corresponding to broadcast/multicast services in a single cell (e.g., SC-RNTI) and/or across multiple cells. In another implementation, a specific RNTI may be used for scheduling of a DL physical channel for transmission of (DL) data traffic corresponding to broadcast/multicast services in a single cell (e.g., G-RNTI) and/or across multiple cells.

In one example, the UE may trigger a broadcast/multicast MAC CE and/or report a broadcast/multicast RRC message and/or report a HARQ ACK/NACK if the UE receives a DCI associated with a specific RNTI, which is used to schedule a DL physical channel for transmission of a (DL) data traffic corresponding to broadcast/multicast services in a single cell (e.g., G-RNTI). Moreover, the broadcast/multicast MAC CE may be considered as being triggered by the broadcast/multicast service that is transmitted on the DL physical channel scheduled by the specific RNTI.

Specifically, the (DL data corresponding to) broadcast/multicast service may be scheduled by a specific DCI. In one implementation, a specific DCI may correspond to a specific CORESET/search space configuration. The NW may configure a specific CORESET/search space configuration to a UE for the reception of scheduling information of a (DL) broadcast/multicast service. In another implementation, a specific DCI may have a specific DCI format. In another implementation, a specific DCI may have a specific DCI field to indicate whether a broadcast/multicast MAC CE is triggered or needs to be transmitted. In another implementation, a specific DCI may have a specific DCI field to indicate whether a broadcast/multicast RRC message needs to be reported.

In another implementation, the DCI format 1_0/1_1 scrambled with common RNTI (e.g., SI-RNTI, P-RNTI, etc), UE-specific RNTI (e.g., C-RNTI, MCS-C-RNTI, etc) or MBS-related RNTI (e.g., M-RNTI, G-RNTI, etc) may have some fields (e.g., the field used to indicate the resource allocation of a (DL) broadcast/multicast service, the field used to indicate the UL resource for transmitting the feedback of a (DL) broadcast/multicast service, etc.) used for carrying scheduling information of a (DL) broadcast/multicast service.

In one example, the UE may trigger a broadcast/multicast MAC CE and/or report a broadcast/multicast RRC message and/or report a HARQ ACK/NACK if the UE receives DCI corresponding to a specific CORESET/search space configuration. Moreover, the broadcast/multicast MAC CE may be considered as being triggered by the broadcast/multicast service that corresponds to the (DL) data scheduled by the DCI.

In one example, the UE may trigger a broadcast/multicast MAC CE and/or report a broadcast/multicast RRC message if the UE may receive DCI corresponding to a specific CORESET/search space configuration.

Specifically, data (e.g., MAC PDU/TB) of the broadcast/multicast service may correspond to a specific (broadcast/multicast) HARQ process. In one alternative, the NW may indicate the (broadcast/multicast) HARQ process via the DCI field which schedules the resource for transmitting data (e.g., MAC PDU/TB) of the broadcast/multicast service. In another alternative, the NW may indicate the HARQ process via dedicated signaling (e.g., RRC signaling) or broadcast SI (e.g., SIB). In one alternative, each HARQ process may correspond to a specific broadcast/multicast service, and the mapping table between HARQ process(es) and broadcast/multicast service may be provided by the NW (e.g., via dedicated signaling, via SI, or via control signaling related to broadcast/multicast services).

In one implementation, a specific HARQ process may correspond to a specific HARQ ID value. In one example, the UE may trigger a broadcast/multicast MAC CE and/or report a broadcast/multicast RRC message if the UE receives a (DL) data (e.g., MAC PDU/TB) of a broadcast/multicast service that associates with a specific (broadcast/multicast) HARQ process. Moreover, the broadcast/multicast MAC CE may be considered as being triggered by the broadcast/multicast service that corresponds to the (DL) data.

Specifically, the broadcast/multicast service may correspond to (or is only available to) a specific geographical area, e.g., MBSFN area, SI area, RAN notification area, tracking area, etc.. In one implementation, a specific geographical area may be associated with a specific area ID (e.g., identified by mbsfn-AreaIndex, systemInformationAreaID, RAN-NotificationAreaInfo, RAN-AreaCode, TrackingAreaCode, etc.). The NW may indicate the area ID associated with the (scheduling information of) the broadcast/multicast service via dedicated signaling or broadcast SI (e.g., SIB). Different broadcast/services may be provided, to a UE, at different geographical areas.

In one example, the UE may trigger a broadcast/multicast MAC CE and/or report a broadcast/multicast RRC message and/or report a HARQ ACK/NACK if the UE receives (the data of) a broadcast/multicast service that corresponds to a specific geographical area. Moreover, the broadcast/multicast MAC CE may be considered as being triggered by the broadcast/multicast service that corresponds to a specific geographical area. In one example, the UE may trigger a broadcast/multicast MAC CE and/or report a broadcast/multicast RRC message and/or report a HARQ ACK/NACK if the UE may receive (the data of) a broadcast/multicast service that corresponds to a specific geographical area.

Specifically, the broadcast/multicast service may be received by the UE at a specific time (period).

In one implementation, a specific time (period) may be referred to as a specific symbol number, slot number, subframe number, radio frame number, etc. The specific time when a broadcast/multicast service may be provided may be indicated by the NW via dedicated signaling or broadcast SI (e.g., SIB). As such, the NW may separate different broadcast/multicast services in the time domain.

In one example, the NW may indicate to a UE the time information (e.g., the symbol number, slot number, subframe number, radio frame number) where a broadcast/multicast service may be provided. Subsequently, the UE may trigger a broadcast/multicast MAC CE and/or report a broadcast/multicast RRC message and/or report a HARQ ACK/NACK if the UE receives (the data of) a broadcast/multicast service at a specific time (e.g., specific symbol number, slot number, subframe number, radio frame number, etc.). Moreover, the broadcast/multicast MAC CE may be considered as being triggered by the broadcast/multicast service that is received at a specific time.

Condition 2: A specific timer has expired.

Specifically, a timer named MBMS timer may be introduced to control the triggering and/or reporting of broadcast/multicast MAC CE. The MBMS timer may be used to represent whether the broadcast/multicast MAC CE should be reported. Hence, the MBMS timer may avoid the UE from triggering and/or reporting a broadcast/multicast MAC CE every time the UE receives (DL) data of a broadcast/multicast service. Alternatively, the MBMS timer may be used to represent whether the broadcast/multicast RRC message should be reported and/or whether a HARQ ACK/NACK should be reported. Hence, the MBMS timer may avoid the UE from reporting a RRC message and/or a HARQ ACK/NACK every time the UE receives (DL) data of a broadcast/multicast service.

In one example, the UE may trigger a broadcast/multicast MAC CE and/or report a broadcast/multicast RRC message and/or report a HARQ ACK/NACK when the MBMS timer expires; alternatively, the UE may not trigger broadcast/multicast MAC CE and/or may not report a broadcast/multicast RRC message and/or may not report a HARQ ACK/NACK if the MBMS_timer is running. In another example, the UE may not report a broadcast/multicast MAC CE and/or may not report a broadcast/multicast RRC message and/or may not report a HARQ ACK/NACK when the MBMS_timer is running; alternatively, the UE may report a broadcast/multicast MAC CE and/or report a broadcast/multicast RRC message and/or report a HARQ ACK/NACK when the MBMS_timer is not running (e.g., when the MBMS_timer stops or when the MBMS_timer expires).

In one example, when a UE receives (the data of) a broadcast/multicast service, the UE may trigger/report a broadcast/multicast MAC CE and/or report a broadcast/multicast RRC message and/or report a HARQ ACK/NACK if the MBMS_timer is not running. Otherwise, the UE may not trigger/report a broadcast/multicast MAC CE and/or may not report a broadcast/multicast RRC message and/or may not report a HARQ ACK/NACK.

In one implementation, the MBMS_timer may be configured, by the NW, via dedicated signaling. In one implementation, the MBMS_timer may be configured, by the NW, via broadcast SI (e.g., SIB). In one implementation, the MBMS_timer may be preconfigured at a UE.

In one implementation, the MBMS_timer may be configured per broadcast/multicast service (e.g., per broadcast/multicast session), per BWP, per cell, per CG, per MAC entity, per UE, etc.

In one implementation, the MBMS_timer may be (re)started when the UE triggers a broadcast/multicast MAC CE. In another implementation, the MBMS_timer may be (re)started when a UL resource becomes available (for the transmission of a broadcast/multicast MAC CE). In another implementation, the MBMS_timer may be (re)started when a broadcast/multicast MAC CE is transmitted. In another implementation, the MBMS_timer may be (re)started when being reconfigured. In another implementation, the MBMS_timer may be (re)started after handover procedure/conditional handover procedure/conditional re-configuration procedure. In another implementation, the MBMS_timer may be (re)started when a broadcast/multicast MAC CE is transmitted and/or a broadcast/multicast RRC message is reported and/or a HARQ ACK/NACK is reported.

In another implementation, the MBMS_timer may be (re)started at the end of a modification period for a control channel corresponding to a broadcast/multicast service (e.g., SC-MCCH or MCCH). The modification period may be configured by the NW. Moreover, the NW may provide the same control signaling on a control channel (e.g., SC-MCCH or MCCH) for broadcast/multicast service within the same modification period.

In one aspect of the implementation, the MBMS_timer may be (re)started at the end a modification period only if the UE receives an indication (e.g., via DCI) to indicate the change of control signaling on a control channel (e.g., SC-MCCH or MCCH) for broadcast/multicast service in the next modification period.

In one implementation, if assuming the MBMS_timer is configured per broadcast/multicast service, then the MBMS_timer may be stopped when the broadcast/multicast service that the MBMS_timer corresponds to is no longer provided by the NW.

In one implementation, if assuming the MBMS_timer is configured per BWP/cell, then the MBMS_timer may be stopped when the corresponding BWP/cell (where the MBMS timer is configured) has been deactivated.

In one implementation, the MBMS_timer may be stopped when the active BWP is switched. In another implementation, the MBMS_timer may be stopped when the associated MAC entity is reset. In another implementation, the MBMS_timer may be stopped when the MBMS_timer is reconfigured.

In one implementation, the MBMS_timer may be stopped upon the UE initiates an RA procedure. Moreover, the RA procedure may be initiated as part of reconfigurationwithsync procedure, TA advance misalignment, SI request procedure, handover procedure, conditional handover procedure, conditional re-configuration procedure, etc.

In one implementation, the MBMS_timer may be stopped when the UE performs cell (re)selection. In another implementation, the unit of the MBMS_timer may be in milliseconds, seconds, symbols, slots, subframes, radio frames, etc.

Condition 3: A specific counter has reached a threshold.

Specifically, a counter may be introduced to count the (consecutive) number of times that a UE fails to receive (control information and/or data, e.g., MAC PDU/TB, related to) from a specific broadcast/multicast service in the DL. If the number of times that the UE fails to receive (control information and/or data, e.g., MAC PDU/TB, related to) broadcast/multicast service in the DL has reached a threshold (e.g., the introduced counter has reached a threshold), the UE may trigger a broadcast/multicast MAC CE and/or report a broadcast/multicast MAC CE and/or report a HARQ ACK/NACK.

Specifically, a counter may be introduced to count the (consecutive) number of times that a UE fails to receive a MAC PDU/TB corresponding to a (broadcast/multicast) HARQ process. If the number of times that the UE fails to receive a MAC PDU/TB of a (broadcast/multicast) HARQ process has reached a threshold (e.g., the introduced counter has reached a threshold), the UE may trigger a broadcast/multicast MAC CE and/or report a broadcast/multicast MAC CE and/or report a HARQ ACK/NACK.

Specifically, the counter may be used to calculate a ratio that the UE fails to receive (control information and/or data, e.g., MAC PDU/TB, related to) broadcast/multicast service in the DL. The ratio may be the number of times that the UE fails to receive a (control information and/or data, e.g., MAC PDU/TB, related to) broadcast/multicast service over the number of times that the UE successfully receives (control information and/or data, e.g., MAC PDU/TB, related to) broadcast/multicast service.

In one example, if the counter has reached a threshold, the UE may trigger/report a broadcast/multicast MAC CE and/or report a broadcast/multicast RRC message and/or report a HARQ ACK/NACK. In another example, if the ratio has reached a threshold, the UE may trigger/report a broadcast/multicast MAC CE and/or report a broadcast/multicast RRC message.

In one implementation, the threshold may be configured, by the NW, via dedicated signaling. In another implementation, the threshold may be configured, by the NW, via broadcast SI (e.g., SIB). In another implementation, the threshold may be preconfigured at a UE.

In one implementation, the counter may be maintained per broadcast/multicast service (e.g., per broadcast/multicast session), per (multicast/broadcast) HARQ process, per BWP, per cell, per CG, per MAC entity, per UE, etc.

In one implementation, the counter may be incremented when a UE does not receive a (control information and/or data related to) broadcast/multicast service in the configured or pre-configured occasions for the reception of broadcast/multicast services. This may be under the assumption that the UE has been configured, by the NW, with the occasions for the reception of broadcast/multicast services (e.g., via broadcast SI). Moreover, an occasion for the reception of broadcast/multicast service may be a PMCH occasion (for the reception of MCCH or MTCH).

In one implementation, the counter may be incremented when a UE (e.g., the MAC entity) fails to decode the data (e.g., MAC PDU/TB). In another implementation, the counter may be incremented when a UE receives a retransmission of data (e.g., data from control channel and/or traffic channel) related to broadcast/multicast service.

In one implementation, the counter may be reset at the end of a modification period for a control channel corresponding to a broadcast/multicast service (e.g., SC-MCCH or MCCH). The modification period may be configured by the NW. Moreover, the NW may provide the same control signaling on a control channel (e.g., SC-MCCH or MCCH) for broadcast/multicast service within the same modification period. In one aspect of the implementation, the counter may be reset at the end a modification period only if the UE receives an indication (via DCI) to indicate the change of control signaling on a control channel (e.g., SC-MCCH or MCCH) for broadcast/multicast service in the next modification period. In another implementation, the counter may be reset if the UE receives an indication (via DCI) to indicate the change of control signaling on a control channel (e.g., SC-MCCH or MCCH) for broadcast/multicast service.

In one implementation, if assuming the counter is maintained per broadcast/multicast service, then the counter may be reset when the broadcast/multicast service that the counter corresponds to is no longer provided by the NW. In another implementation, if assuming the counter is maintained per BWP/cell, then the counter may be reset when the corresponding BWP/cell (where the counter is configured) has been deactivated. In another implementation, the counter may be reset when the UE (in RRC_IDLE or RRC_INACTIVE state) performs cell (re)selection. In another implementation, if assuming the counter is maintained per (broadcast/multicast) HARQ process, the counter may be reset upon reception of a scheduling of new transmission for a (broadcast/multicast) HARQ process.

In one implementation, the counter may be reset upon a TB corresponding broadcast/multicast service in the DL is received successfully. In another implementation, the counter associated with the corresponding service may be reset when the associated MAC entity is reset.

In some implementations, a timer named Consecutive_failure_timer may be introduced to count the number of times that a UE fails to receive (control information and/or data, e.g., MAC PDU/TB, related to) broadcast/multicast service in the DL within a specific period. In one example, Consecutive_failure_timer may be used to reset the counter if the UE does not fail to receive (control information and/or data, e.g., MAC PDU/TB, related to) broadcast/multicast service in the DL within a defined period. The counter may be stopped when Consecutive_failure_timer expires.

In one implementation, the Consecutive_failure_timer may be (re)started when the counter is incremented.

In one implementation, the Consecutive_failure_timer may be stopped upon initiation of an RA procedure. Moreover, the RA procedure may be initiated as part of reconfigurationwithsync procedure, TA advance misalignment, SI request procedure, handover procedure, conditional handover procedure, conditional re-configuration procedure to another cell, etc. In another implementation, the Consecutive_failure_timer may be stopped upon initiation of RRC connection re-establishment procedure, e.g., upon T311, as introduced in 3GPP TS 38.331 V16.0.0, counting has been (re)started.

Specifically, a UE failing to receive (control information and/or data, e.g., MAC PDU/TB, related to) broadcast/multicast service in the DL may imply the UE does not receive the MAC PDU/TB of the broadcast/multicast service at the scheduled/configured DL resource.

Specifically, a UE failing to receive (control information and/or data, e.g., MAC PDU/TB, related to) broadcast/multicast service in the DL may imply the UE does not successfully decode the received MAC PDU/TB of the broadcast/multicast service.

In one implementation, the PHY layer may send an indication to the MAC entity to indicate the UE fails to receive (control information and/or data, e.g., MAC PDU/TB, related to) broadcast/multicast service in the DL.

Condition 4: The UE has been indicated explicitly, from the NW, to provide UL feedback.

Specifically, the NW may explicitly indicate to a UE whether to provide UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service in the DL. Moreover, the NW may explicitly indicate whether this UL feedback may be transmitted via a UL resource, which is configured/scheduled for a UE for transmission while the UE is in the RRC_INACTIVE or the RRC_IDLE state.

In one example, if a UE is explicitly indicated by the NW, the UE may provide UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service in the DL.

In one example, if a UE is not explicitly indicated by the NW, the UE may not provide UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service in the DL.

In one implementation, the indication may be configured, by the NW, via a dedicated RRC signaling (e.g., RRCRelease message, RRCReconfiguration message, etc.). In another implementation, the indication may be configured, by the NW, via a MAC CE and/or a DCI. In another implementation, the indication may be configured, by the NW, via broadcast SI (e.g., SIB). In another implementation, the indication may be preconfigured in a specific UE, e.g., UE with a specific UE capability set. In another implementation, the indication may be configured per (DL or UL) BWP, per cell, per UE, per broadcast/multicast service, etc. In another implementation, the dedicated RRC signaling, the MAC CE, and/or the DCI may configure a corresponding function to report the UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service in the DL.

In one implementation, the control information and/or data, e.g., MAC PDU/TB, related to) broadcast/multicast service in the DL may correspond to a (broadcast/multicast) HARQ process. Hence, if a UE is explicitly indicated by the NW to perform UL feedback for a first broadcast/multicast service, the UE may, upon successful reception of a MAC PDU/TB that corresponds to the first broadcast/multicast service, report a HARQ ACK that corresponds to the HARQ process of the MAC PDU/TB. Alternatively, the UE may, upon unsuccessful reception of a MAC PDU/TB that corresponds to the first broadcast/multicast service, report a HARQ NACK that corresponds to the HARQ process of the MAC PDU/TB. Moreover, the UE may not need to perform HARQ ACK/NACK feedback for a MAC PDU/TB that corresponds to a second broadcast/multicast service, which is different from the first broadcast/multicast service, if the UE is not explicitly indicated by the NW to perform UL feedback for a MAC PDU/TB corresponding to the second broadcast/multicast service.

In one implementation, the control information and/or data, e.g., MAC PDU/TB, related to) broadcast/multicast service in the DL may correspond to a (broadcast/multicast) HARQ process. Hence, if a UE is explicitly indicated by the NW to perform UL feedback in response to data received at a first DL BWP/serving cell, the UE may, upon successful reception of a MAC PDU/TB at the first DL BWP/serving cell, report a HARQ ACK that corresponds to the HARQ process of the MAC PDU/TB. Alternatively, the UE may, upon unsuccessful reception of a MAC PDU/TB at the first DL BWP/serving cell, report a HARQ NACK that corresponds to the HARQ process of the MAC PDU/TB. Moreover, the UE may not need to perform HARQ ACK/NACK feedback for a MAC PDU/TB received at a second DL BWP/serving cell, which is different from the first DL BWP/serving cell, if the UE is not explicitly indicated by the NW to perform UL feedback for a MAC PDU/TB received at the second DL BWP/serving cell.

In one implementation, the UE may provide UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service in the DL after being explicitly indicated, by the NW, from multiple signaling, e.g., at least one of dedicated RRC signaling, a MAC CE, and DCI. Otherwise, the UE may not provide UL feedback. Here, the NW may explicitly indicate to the UE via the RRC signaling before the NW explicitly indicates to the UE via the MAC CE/DCI. In one example, the UE may only provide UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service in the DL if the UE receives the explicit indication via both the RRC signaling and the MAC CE/DCI.

In one example, if a UE is configured with the explicit indication in DL BWP i/Cell i/frequency range i, the UE may provide UL feedback (e.g., trigger/report broadcast/multicast MAC CE, report broadcast/multicast RRC message, report HARQ ACK/NACK, etc.) in response to a (control information and/or data, e.g., MAC PDU/TB, related to) broadcast/multicast service received in DL BWP i/Cell i/frequency range i. Alternatively, if a UE is not configured with the explicit indication in DL BWP i/Cell i/frequency range i, the UE may not provide UL feedback (e.g., trigger/report broadcast/multicast MAC CE, report HARQ ACK/NACK, report broadcast/multicast RRC message, etc.) in response to a (control information and/or data, e.g., MAC PDU/TB, related to) broadcast/multicast service received in DL BWP i/Cell i/frequency range i. Moreover, the DL BWP i/Cell i/frequency range i may be a specific DL BWP/Cell/frequency range as mentioned in the present disclosure.

In one implementation, the NW may explicitly indicate/configure a list of one or multiple DL BWP(s)/Cell(s)/frequency range(s), in which UL feedback may be reported, if any MAC PDU/TB is received at the list of one or multiple DL BWP(s)/Cell(s)/frequency range(s).

In one implementation, the NW may explicitly indicate/configure a list of one or multiple broadcast/multicast service(s), in which UL feedback may be reported, if any MAC PDU/TB corresponding to the list of one or multiple broadcast/multicast service(s) is received.

In one implementation, whether a UE is enabled to provide UL feedback (e.g., trigger/report broadcast/multicast MAC CE, report broadcast/multicast RRC message, report HARQ ACK/NACK, etc.) depends on the UL BWP associated with the DL BWP configured to the concerned broadcast/multicast service. In one example, the UE may provide UL feedback if a UL resource (e.g., PUCCH resource and/or PUSCH resource) for UL feedback has been configured on the UL BWP associated with the DL BWP where a broadcast/multicast service is received. Alternatively, the UE may not provide UL feedback if the UL resource (e.g., PUCCH resource and/or PUSCH resource) is not configured on the corresponding UL BWP. In this case, the UE may initiate an RA procedure instead.

Condition 5: The UE has indicated its capability to support UL feedback.

Specifically, the UE may provide capability information regarding whether the UE is capable of supporting UL feedback transmission (e.g., trigger/report broadcast/multicast MAC CE, report HARQ ACK/NACK, report broadcast/multicast RRC signaling, etc.) in response to a (control information and/or data, e.g., MAC PDU/TB, related to) broadcast/multicast service in the DL. Such a capability information may be signaled from the UE to the NW in form of UE radio access capability parameters. The NW may consider the signaled UE radio access capability parameters when configuring the UE and when scheduling the UE.

In one implementation, one or multiple of the capability information (e.g., radio access capability parameters) as shown below may be transmitted from a UE to its serving NW via (dedicated) RRC signaling. In one example, one or multiple of the capability information (e.g., UE radio access capability parameters) as shown below may be transmitted from a UE to its serving NW via UEAssistanceInformation message, as introduced in 3GPP TS 38.331 V16.0.0. In another example, one or multiple of the capability information (e.g., UE radio access capability parameters) may be transmitted from a UE to its serving NW via UECapabilityInformation message, e.g., after the UE receives a UECapabilityEnqiry message, as introduced in 3GPP TS 38.331 V16.0.0, from its serving NW. The one or multiple of the capability information are introduced in the following.

In one example, a capability information (e.g., radio access capability parameters) may define whether the UE supports UL feedback (e.g., HARQ feedback, trigger/report broadcast/multicast MAC CE, report broadcast/multicast RRC signaling, etc.) in response to reception of (control information and/or data, e.g., MAC PDU/TB, related to) broadcast/multicast service across multiple cells (e.g., MBMS reception via MBSFN).

In another example, a capability information (e.g., radio access capability parameters) may define whether the UE supports UL feedback (e.g., trigger/report broadcast/multicast MAC CE, report broadcast/multicast RRC signaling, etc.) to indicate its interest of receiving (control information and/or data, e.g., MAC PDU/TB, related to) broadcast/multicast service across multiple cells.

In another example, a capability information (e.g., radio access capability parameters) may define whether the UE supports UL feedback (e.g., HARQ feedback, trigger/report broadcast/multicast MAC CE, report broadcast/multicast RRC signaling, etc.) in response to reception of (control information and/or data, e.g., MAC PDU/TB, related to) broadcast/multicast service in a single cell (e.g., MBMS reception via SC-PTM).

In another example, a capability information (e.g., radio access capability parameters) may define whether the UE supports UL feedback (e.g., trigger/report broadcast/multicast MAC CE, report broadcast/multicast RRC signaling, etc.) to indicate its interest of receiving (control information and/or data, e.g., MAC PDU/TB, related to) broadcast/multicast service in a single cell.

In one implementation, if a UE has indicated the NW that the UE is capable of supporting UL feedback (e.g., HARQ feedback, trigger/report broadcast/multicast MAC CE, report broadcast/multicast RRC signaling, etc.) in response to reception of (control information and/or data, e.g., MAC PDU/TB, related to) broadcast/multicast service, the UE may trigger a broadcast/multicast MAC CE and/or report a broadcast/multicast RRC message upon reception of (control information and/or data, e.g., MAC PDU/TB, related to) broadcast/multicast service.

Condition 6: timeAlignmentTimer has not expired.

Specifically, when the timeAlignmentTimer associated with the PTAG is not running, the UE (e.g., the MAC entity) may not perform any uplink transmission on any serving cell except the RA preamble transmission on the SpCell.

Specifically, the UE (e.g., MAC entity) may not perform any uplink transmission on a serving cell except the RA preamble transmission when the timeAlignmentTimer associated with the TAG to which this serving cell belongs is not running.

In one example, if the timeAlignmentTimer associated with the PTAG is not running, the UE (e.g., the MAC entity) may not trigger broadcast/multicast MAC CE and/or report a broadcast/multicast RRC message in response to reception of (control information and/or data, e.g., MAC PDU/TB, related to) broadcast/multicast service.

In one example, if the timeAlignmentTimer associated with a TAG is not running, the UE (e.g., the MAC entity) may not trigger broadcast/multicast MAC CE and/or report a broadcast/multicast RRC message in response to reception of (control information and/or data, e.g., MAC PDU/TB, related to) broadcast/multicast service on a serving cell that belongs to this TAG.

Condition 7: Content of broadcast/multicast MAC CE or broadcast/multicast RRC message has been changed/updated.

Specifically, when a UE has reported a first broadcast/multicast MAC CE, the UE is only allowed to report a second broadcast/multicast MAC CE which has different content compared to the first broadcast/multicast MAC CE.

Specifically, when a UE has reported a first broadcast/multicast RRC message, the UE is only allowed to report a second broadcast/multicast RRC message which has different content compared to the first broadcast/multicast RRC message.

Condition 8: The NW has indicated to the UE that the NW supports broadcast/multicast service.

Specifically, the NW may indicate to a UE that the NW supports one or multiple broadcast/multicast services via dedicated signaling or broadcast SI (e.g., SIB).

In one implementation, a UE may trigger a broadcast/multicast MAC CE and/or report a broadcast/multicast RRC message only if the broadcast/multicast service that the UE is interested in is supported by the NW via the indication. Moreover, the broadcast/multicast MAC CE may be considered as being triggered by the broadcast/multicast service that the UE is interested in.

Condition 9: When the UE leaves a specific geographical area.

Specifically, a specific geographical area (e.g., MBSFN area, SI area, RAN notification area, tracking area, etc.) may correspond to (or is only available to) one or multiple broadcast/multicast services.

In one implementation, a specific geographical area may be associated with a specific area ID (e.g., identified by mbsfn-AreaIndex, systemInformationAreaID, RAN-NotificationAreaInfo, RAN-AreaCode, TrackingAreaCode, etc.). The NW may indicate the area ID associated with the (scheduling information of) the broadcast/multicast service via dedicated signaling or broadcast SI (e.g., SIB). Different broadcast/services may be provided, to a UE, at different geographical areas.

In one example, the UE may trigger a broadcast/multicast MAC CE and/or report a broadcast/multicast RRC message if the UE leaves a specific geographical area associated with its interested broadcast/multicast service. Moreover, the UE may trigger a broadcast/multicast MAC CE and/or report a broadcast/multicast RRC message only if it is receiving one or multiple broadcast/multicast services while leaving the specific geographical area.

Condition 10: When the UE no longer needs the broadcast/multicast service.

Specifically, the UE no longer needs the broadcast/multicast service if the UE loses interest in a broadcast/multicast service. In one example, the UE may trigger a broadcast/multicast MAC CE and/or report a broadcast/multicast RRC message if the UE no longer needs to receive any broadcast/multicast services. In another example, the UE may trigger a broadcast/multicast MAC CE and/or report a broadcast/multicast RRC message if the UE no longer needs to receive a broadcast/multicast service with specific characteristics (as described as part of condition 1). Moreover, the broadcast/multicast MAC CE may be considered as being triggered by the broadcast/multicast service with specific characteristics.

Content of Broadcast/Multicast MAC CE and/or Content of the Broadcast/Multicast RRC Message

As mentioned earlier, the broadcast/multicast MAC CE and/or broadcast/multicast RRC message may be used to explicitly/implicitly indicate whether a broadcast/multicast specific service has been received. Alternatively, the broadcast/multicast MAC CE and/or broadcast/multicast RRC message may be used to indicate the preferred broadcast/multicast service(s) that a UE would like to receive. In this sense, the broadcast/multicast MAC CE and/or broadcast/multicast RRC message may include one or multiple of the information listed below:

A list of one or multiple broadcast/multicast service(s) that the UE is currently receiving.

Specifically, the broadcast/multicast MAC CE and/or the broadcast/multicast RRC message may be used to inform the NW a list of one or multiple broadcast/multicast service(s) that the UE is currently receiving.

In one alternative, the list may include all the broadcast/multicast service(s) that the UE is currently receiving. In one alternative, the list may include the broadcast/multicast service(s) that triggers the broadcast/multicast MAC CE. For example, if a UE is currently receiving broadcast/multicast service 1, 2, and 3. However, if only service 1 and 2 triggers the broadcast/multicast MAC CE (due to specific broadcast/multicast service characteristics as described earlier), the broadcast/multicast MAC CE may only include information related to broadcast/multicast service 1 and 2.

In one implementation, a list of one or multiple broadcast/multicast services that the UE is currently receiving may be represented as a list of one or multiple broadcast/multicast service ID(s), e.g., a list of one or multiple broadcast/multicast session ID(s) (e.g., sessionId), a list of one or multiple broadcast/multicast service ID(s) (e.g., serviceId), a list of one or multiple temporary mobile group identity(s) (e.g., TMGI), etc.

In one implementation, a list of one or multiple broadcast/multicast services that the UE is currently receiving may be represented as a list of broadcast/multicast frequencies (e.g., frequency range, BWP, cell, etc). Each broadcast/multicast frequency may correspond to one (or multiple) broadcast/multicast service.

In one implementation, the broadcast/multicast MAC CE may include a bitmap. Each bit may correspond to a specific broadcast/multicast service.

In one example, the first bit of the bit map is associated with the first entry of the broadcast/multicast service listed as provided by the NW via dedicated signaling or broadcast SI. In another example, the first bit of the bit map is associated with the broadcast/multicast service with broadcast/multicast service ID of 1. Moreover, the service ID may be a sessionId, serviceId, TMGI, etc. In another example, a value of “1” from a bit in the bitmap may indicate that the UE is currently receiving the broadcast/multicast service corresponding to this bit. A value of “0” from a bit in the bitmap may indicate that the UE is not receiving (or not reporting, or not interested in) the broadcast/multicast service corresponding to this bit.

Request for One or Multiple Broadcast/Multicast Services.

Specifically, the broadcast/multicast MAC CE and/or the broadcast/multicast RRC message may be used to request the NW for one or multiple broadcast/multicast service(s) (e.g., the UE may indicate the broadcast/multicast service(s) that the UE is interested in receiving).

Specifically, a broadcast/multicast services that a UE requests may be limited to the broadcast/multicast service that is supported but is not provided by the NW (e.g., a serving cell) at the moment.

In one implementation, the UE may request the NW for one or multiple broadcast/multicast service(s) via a list of one or multiple broadcast/multicast ID(s). In one example, the UE may request the NW for one or multiple broadcast/multicast service(s) via a list of one or multiple broadcast/multicast session ID(s) (e.g., sessionId). In another example, the UE may request the NW for one or multiple broadcast/multicast service(s) via a list of one or multiple broadcast/multicast service ID(s) (e.g., serviceId). In another example, the UE may request the NW for one or multiple broadcast/multicast service(s) via a list of one or multiple temporary mobile group identity(s) (e.g., TMGI) associated with the broadcast/multicast service(s). In another example, the UE may request the NW for one or multiple broadcast/multicast service(s) via a list of one or multiple broadcast/multicast frequencies. Each broadcast/multicast frequency may correspond to one (or multiple) broadcast/multicast service.

In one implementation, the broadcast/multicast MAC CE may include a bitmap. Each bit may correspond to a specific broadcast/multicast service that a UE may receive. In one example, the first bit of the bit map is associated with the first entry of the broadcast/multicast service listed as provided by the NW via dedicated signaling or broadcast SI. In another example, the first bit of the bit map is associated with the broadcast/multicast service with broadcast/multicast service ID of 1. Moreover, the service ID may be a sessionId, serviceId, TMGI, etc.

In one example, a value of “1” from a bit in the bitmap may indicate that the UE may receive the broadcast/multicast service corresponding to this bit. A value of “0” from a bit in the bitmap may indicate that the UE is not interested in receiving the broadcast/multicast service corresponding to this bit.

In one implementation, if the broadcast/multicast MAC CE and/or the broadcast/multicast RRC message is used to request the NW for one or multiple broadcast/multicast service(s), the UE may start monitoring a specific DL resource upon transmission of the broadcast/multicast MAC CE and/or the broadcast/multicast RRC message. In one alternative, the specific DL resource may be a specific CORESET/search space for scheduling of a broadcast/multicast service. In one alternative, the specific DL resource may be a specific DL resource for reception of a broadcast/multicast service (e.g., PMCH).

A List of One or Multiple Broadcast/Multicast Service(s) that the UE is Currently Receiving, and in Which the UE has Missed the Corresponding DL Data (or in Which the UE has Not Received Any Corresponding DL Data in a Time Period).

Specifically, a UE is currently receiving a broadcast/multicast service if the radio bearer (e.g., MRB or SC-MRB) of this broadcast/multicast service has been established and has not yet been released. Specifically, the DL data may be a MAC PDU/TB (corresponding to a (broadcast/multicast) HARQ process. Moreover, the UE misses the DL data of a broadcast/multicast service if the corresponding TB is not successfully decoded/received (for a number of times).

In one implementation, the broadcast/multicast MAC CE may include a bitmap. Each bit may correspond to a specific broadcast/multicast service that the UE is currently receiving, and in which the UE has missed the corresponding DL data (or in which the UE has not received any corresponding DL data in a time period). In one example, the first bit of the bit map is associated with the first entry of the broadcast/multicast service listed as provided by the NW via dedicated signaling or broadcast SI. In another example, the first bit of the bit map is associated with the broadcast/multicast service with broadcast/multicast service ID of 1. Moreover, the service ID may be a sessionld, serviceld, TMGI, etc.

In one example, a value of “1” from a bit in the bitmap may indicate that the UE is currently receiving a broadcast/multicast service, and in which the UE has missed the corresponding DL data (or in which the UE has not received any corresponding DL data in a time period). A value of “0” from a bit in the bitmap may indicate that the UE is currently receiving a broadcast/multicast service, and in which the UE has not missed the corresponding DL data. In another example, a value of “0” from a bit in the bitmap may indicate that the UE is currently receiving a broadcast/multicast service, and in which the UE has missed the corresponding DL data (or in which the UE has not received any corresponding DL data in a time period). A value of “1” from a bit in the bitmap may indicate that the UE is currently receiving a broadcast/multicast service, and in which the UE has not missed the corresponding DL data.

HARQ-Based UL Feedback

HARQ Process ID Determination

A HARQ-based UL feedback mechanism may be supported for one or multiple NR broadcast/multicast service(s). To achieve this, for each NR broadcast/multicast service, one or multiple HARQ process(es) and its corresponding soft buffer may be needed.

In one embodiment, the NW may provide HARQ information related to the broadcast/multicast service(s) that a UE is receiving. The HARQ information may be signaled via dedicated signaling (while the UE is in the RRC_CONNECTED), e.g., DCI/dedicated RRC signaling, or via broadcast SI (while the UE is in the RRC_IDLE state or the RRC_INACTIVE state), e.g., SIB.

Specifically, the HARQ information may explicitly indicate the exact (range of) (broadcast/multicast) HARQ process IDs associated with each broadcast/multicast service. In one example, the NW may indicate to the UE that (broadcast/multicast) HARQ process IDs associated with broadcast/multicast service 1 is (broadcast/multicast) HARQ process 1, 3, and 5. In another example, the NW may indicate to the UE that the range of (broadcast/multicast) HARQ process IDs occupied by broadcast/multicast service 1 is from HARQ ID 1 to HARQ ID 4 (e.g., HARQ 1, 2, 3, and 4).

Specifically, the HARQ information may include the number of HARQ process IDs that is used/occupied by a broadcast/multicast service. Subsequently, the UE may derive the HARQ process ID of each received DL resource (e.g., PDSCH, PMCH, etc.) associated with the broadcast/multicast service (as described below) based on the number of HARQ process IDs associated with the broadcast/multicast service. Here, the received DL resource may correspond to an SPS configuration that is configured for a group of one or multiple UEs. Moreover, the SPS configuration may correspond to one or multiple broadcast/multicast services.

Specifically, the HARQ information may include a (broadcast/multicast) HARQ offset associated with a broadcast/multicast service. The HARQ offset may be used by the UE for deriving the HARQ process IDs of each received DL resource (e.g., PDSCH, PMCH, etc.) associated a broadcast/multicast service (as described below). By providing the HARQ offset to a UE, the NW may ensure the UE does not derive the same HARQ process ID for DL resources that correspond to different broadcast/multicast services.

In one embodiment, the (range) of HARQ process ID(s) associated with a broadcast/multicast service may be predefined. The UE may determine the (range) of HARQ process ID(s) associated with a broadcast/multicast service based on the broadcast/multicast service ID or other parameters associated with the broadcast/multicast service.

More specifically, a HARQ table with x indices may be predefined (e.g., preconfigured by the UE). Each index may correspond to one or multiple HARQ process IDs. Subsequently, if the broadcast/multicast service ID (or other parameters) of a broadcast/multicast service has a value of y, the broadcast/multicast service may be mapped to the HARQ process ID(s) that corresponds to index y in the HARQ table.

In one embodiment, the UE may derive the HARQ process ID associated with a DL resource (e.g., PDSCH, PMCH, etc.) of a broadcast/multicast service. More specifically, the UE may derive the HARQ process ID associated with a DL resource (e.g., PDSCH, PMCH, etc.) from a broadcast/multicast service based on one or multiple of the following elements shown below.

Element 1: Service Identity Associated with a Broadcast/Multicast Service.

The NW may provide the service identity of a broadcast/multicast service to a UE via dedicated signaling (while the UE is in the RRC_CONNECTED state), e.g., DCI/dedicated RRC signaling, or via broadcast SI (while the UE is in the RRC_IDLE state or the RRC_INACTIVE state), e.g., SIB.

More specifically, a service identity of a broadcast/multicast service(s) may be a broadcast/multicast session ID (sessionId), a broadcast/multicast service ID(s) (e.g., serviceId), and a temporary mobile group identity(s) (e.g., TMGI), etc.

Element 2: Number of HARQ Process IDs Used/Occupied by a Broadcast/Multicast Service.

The number of HARQ process IDs that is used/occupied by a broadcast/multicast service may be indicated by the NW via dedicated signaling (while the UE is in the RRC_CONNECTED state), e.g., DCI/dedicated RRC signaling, or via broadcast SI (while the UE is in the RRC_IDLE state or the RRC_INACTIVE state), e.g., SIB.

In one implementation, the NW may indicate a mapping table which maps the service identity of a broadcast/multicast service to the number of HARQ process IDs used/occupied by that broadcast/multicast service.

Element 3: HARQ Offset Associated with a Broadcast/Multicast Service.

The number of HARQ process IDs that is used/occupied by a broadcast/multicast service may be indicated by the NW via dedicated signaling (while the UE is in the RRC_CONNECTED state), e.g., DCI/dedicated RRC signaling, or via broadcast SI (while the UE is in the RRC_IDLE state or the RRC_INACTIVE state), e.g., SIB.

Element 4: Specific Periodicity of a Broadcast/Multicast Service.

A specific periodicity associated with a broadcast/multicast service may be indicated by the NW via dedicated signaling (while the UE is in the RRC_CONNECTED), e.g., DCI/dedicated RRC signaling, or via broadcast SI (while the UE is in the RRC_IDLE or the RRC_INACTIVE), e.g., SIB.

In one implementation, the specific periodicity of a broadcast/multicast service may be referred to as the periodicity of the DL resource for transmitting (control signaling (e.g., SC-MCCH) and/or data traffic (e.g., SC-MTCH) of) broadcast/multicast services in a single cell (e.g., periodicity of SC-MCH).

In one implementation, the specific periodicity of a broadcast/multicast service may be referred to as the periodicity of the DL resource for transmitting (control signaling (e.g., MCCH) and/or data traffic (e.g., MTCH) of) broadcast/multicast services across multiple cells (e.g., periodicity of MCH).

Specifically, the periodicity of a broadcast/multicast service may be referred to as the scheduling cycle of the DL assignment (e.g., DCI) that schedules the DL resource for transmitting broadcast/multicast services.

Element 5: Time Domain Information Related to the DL Resource of a Broadcast/Multicast Service.

Specifically, the time domain information related to a DL resource associated with a broadcast/multicast service may be derived by the UE via some information as signaled by the NW.

In one implementation, the time domain information related to a DL resource of a broadcast/multicast service may be the SFN where the (starting symbol or ending symbol of the) DL resource associated with a broadcast/multicast service is configured/scheduled. Moreover, the SFN may be signaled by the NW via broadcast SI.

In one implementation, the time domain information related to a DL resource may be the subframe number where the (starting symbol or ending symbol of the) DL resource is configured/scheduled. Moreover, the subframe number may be derived by the UE via the following equation:

Subframe number=(SFN*number of subframes per frame)+subframe number in the frame

In one implementation, the time domain information related to a DL resource may be the slot number where the (starting symbol or ending symbol of the) DL resource associated with a broadcast/multicast service is configured/scheduled. Furthermore, the slot number may be derived by the UE via the following equation:

Slot number=(SFN*number of slots per frame)+slot number in the frame

In one implementation, the time domain information related to a DL resource may be the symbol number where the (starting symbol or ending symbol of the) DL resource associated with a broadcast/multicast service is configured/scheduled. Furthermore, the symbol number may be derived by the UE via the following equation:

Symbol number=(SFN*number of symbols per frame)+symbol number in the frame

In one example, the HARQ process ID associated with DL resource 1 (e.g. PDSCH duration, PMCH, etc.) belonging to broadcast/multicast service 1 may be derived from the following equation:

(Time domain information related to DL resource 1/Specific periodicity of service 1) Modulo (Number of HARQ process IDs used by service 1)+HARQ offset associated with service 1

Conditions to Process the Received TB Corresponding to Broadcast/Multicast service

In one embodiment, upon a UE receiving TB1 corresponding to broadcast/multicast service on DL resource 1 (e.g., PMCH, PDSCH, etc.) and DL resource 1 is associated with (broadcast/multicast) HARQ process ID of 1, the UE may consider the received TB1 as a new transmission if condition A has been satisfied. Otherwise, the UE may consider the received TB1 as a retransmission. Subsequently, if the UE considers TB1 as a new transmission, the UE may attempt to decode TB1. Alternatively, if the UE considers TB1 to be a retransmission, the UE may then check whether the data for TB1 has not been successfully decoded.

In one aspect of the implementation, if the data for TB1 has not been successfully decoded (until TB1 has been received on DL resource 1), the UE may combine the data from TB1 with other data currently in the soft buffer (associated with the HARQ process of TB1) and may attempt to decode the combined data. Moreover, if the data which the MAC entity attempts to decode is successfully decoded for TB1, the UE may generate an ACK for TB1. Alternatively, the UE may generate a NACK for TB1. In one alternative, if the data for TB1 has been successfully decoded (before reception of TB1 on DL resource 1), the UE (e.g., MAC entity) may generate an ACK for TB1.

In one aspect of the implementation, the generated ACK and/or NACK for TB1 may be reported (e.g., transmitted) by the UE when timeAlignmentTimer has not expired.

Condition A: If the NDI of the received TB, e.g., TB1, has been toggled compared with another previously received TB with the same (broadcast/multicast) HARQ process, e.g., (broadcast/multicast) HARQ process 1.

Specifically, the NDI value of TB1 may be indicated via a 1-bit indication. For example, if DL resource 1 (where TB1 is received) is scheduled via a DL assignment (e.g., a DCI), the 1-bit indication to indicate the NDI value may be included in the DL assignment (e.g., DCI) that schedules DL resource 1.

It is noted that in some cases, whether the NDI of the received TB is considered to have been toggled may not always solely depend on the value of the NDI. The UE may consider whether the NDI of the received TB is considered to have been toggled based on some specific criteria.

In one implementation, a DL resource 1 (where TB1 is received) is scheduled by DCI. Moreover, if the DCI that schedules DL resource 1 is a CRC scrambled by a specific RNTI (e.g., G-RNTI, M-RNTI, SC-RNTI, etc.), and another previously received DL resource with the same (broadcast/multicast) HARQ process as the DL resource 1 (e.g., (broadcast/multicast) HARQ process 1) was also scheduled via the DCI with CRC scrambled by the same type of RNTI, the UE may consider the NDI of the received TB, e.g., TB1, on the DL resource 1 to have (or not have) been toggled regardless of the value of the NDI (only if the DL resource 1 and/or the DCI that schedules the DL resource 1 is received by the UE within a certain period of time after the previously received DL resource).

In one implementation, a specific RNTI may be used for scheduling a DL physical resource for transmission of (DL) control signaling corresponding to broadcast/multicast services in a single cell (e.g., SC-RNTI) and/or across multiple cells. Alternatively, a specific RNTI may be an RNTI that is used for scheduling of a DL physical resource for transmission of (DL) data traffic corresponding to broadcast/multicast services in a single cell (e.g., G-RNTI) and/or across multiple cells.

In one example, when a UE (in the RRC_CONNECTED state) receives broadcast/multicast DL resource 1 scheduled by a DCI with CRC scrambled by G-RNTI/C-RNTI, and another previously received DL resource with the same (broadcast/multicast) HARQ process as the DL resource 1 (e.g., (broadcast/multicast) HARQ process 1) was scheduled via the DCI with CRC scrambled by G-RNTI, the UE may consider the NDI of the received TB, e.g., TB1, on the DL resource 1 to have (or not have) been toggled regardless of the value of the NDI (if the DL resource 1 or the DCI that schedules the DL resource 1 is received by the UE within a certain period of time).

In one implementation, if the DL resource 1 (where TB1 is received) is scheduled by a DCI with CRC scrambled by a specific RNTI and/or DCI with a specific DCI format, and the previously received DL resource with the same (broadcast/multicast) HARQ process as the DL resource 1 (e.g., (broadcast/multicast) HARQ process 1) corresponds to a specific (physical) DL channel for multicast broadcast multicast services, the UE may consider the NDI of the received TB, e.g., the TB1, on the DL resource 1 to have (or not have) been toggled regardless of the value of the NDI (only if the DL resource 1 and/or the DCI that schedules the DL resource 1 is received by the UE within a certain period of time after the previously received DL resource).

In one implementation, a specific DCI format may be used for scheduling a DL physical resource for transmission of (DL) control signaling corresponding to broadcast/multicast services in a single cell and/or across multiple cells. Alternatively, a specific DCI format may be used for scheduling a DL physical resource for transmission of (DL) data traffic corresponding to broadcast/multicast services in a single cell and/or across multiple cells.

In one implementation, a specific (physical) DL channel may be used for transmission of (DL) control signaling corresponding to broadcast/multicast services in a single cell (SC-MCCH) and/or across multiple cells (MCCH). Alternatively, a specific (physical) DL channel may be used for transmission of (DL) data traffic corresponding to broadcast/multicast services in a single cell (SC-MTCH) and/or across multiple cells (MTCH).

In one example, if the DL resource 1 (where TB1 is received) is scheduled by a DCI with CRC scrambled by G-RNTI, and the previously received DL resource with the same (broadcast/multicast) HARQ process as the DL resource 1 (e.g., (broadcast/multicast) HARQ process 1) was received on a (physical) DL channel that is specifically for transmission of control signaling or data traffic in a single cell (e.g., SC-MTCH or SC-MCCH), the UE may consider the NDI of the TB (e.g., the TB1) received on the DL resource 1 to have (or not have) been toggled regardless of the value of the NDI (only if the DL resource 1 and/or the DCI that schedules the DL resource 1 is received by the UE within a certain period of time after the previously received DL resource).

In one implementation, if the DL resource 1 (where TB1 is received) is scheduled by a DCI and the DCI is received on a specific search space (e.g., PDCCH), the UE may consider the NDI of the received TB, e.g., the TB1, on the DL resource 1 to have (or not have) been toggled regardless of the value of the NDI (only if the DL resource 1 and/or the DCI that schedules the DL resource 1 is received by the UE within a certain period of time after the previously received DL resource with the same (broadcast/multicast) HARQ process as DL resource 1).

In one implementation, the NW may configure one or a set of periodically occurring specific search space (e.g., PDCCH) via dedicated signaling or broadcast SI (e.g., SIB).

In one implementation, the DCI that is received on the specific search space (e.g., PDCCH) may be specifically used for scheduling retransmission (or new transmission) of a DL resource corresponding to broadcast/multicast service.

In one implementation, if the DL resource 1 (where TB1 is received) is a specific DL resource, the UE may consider the NDI of the received TB, e.g., the TB1, on the DL resource 1 to have (or not have) been toggled regardless of the value of the NDI (only if the DL resource 1 and/or the DCI that schedules the DL resource 1 is received by the UE within a certain period of time after the previously received DL resource with the same (broadcast/multicast) HARQ process as DL resource 1).

In one implementation, a specific (physical) DL resource may be configured by the NW via dedicated signaling or broadcast SI (e.g., SIB).

In one implementation, the NW only schedules a retransmission of a broadcast/multicast service on a specific (physical) DL resource.

In one implementation, a specific (physical) DL resource may correspond to an SPS configuration and the SPS configuration further corresponds to a broadcast/multicast service (e.g., MBMS session). Moreover, the specific DL resource that corresponds to an SPS configuration may be received by a group of one or multiple UEs that are receiving the same broadcast/multicast service.

In one implementation, the NW may indicate the broadcast/multicast service identity that associates to the SPS configuration via dedicated signaling (e.g., SPS-Config IE) or broadcast SI (e.g., SIB). In another implementation, the NW may indicate, via (the presence) an indication, that the SPS configuration corresponds to a broadcast/multicast service. In another implementation, a specific (physical) DL resource may correspond to a specific DL BWP. In another implementation, a specific DL BWP may be configured for the reception of broadcast/multicast service(s). The NW may indicate that the specific DL BWP is for the reception of broadcast/multicast service(s) via dedicated signaling (e.g., BWP -Dow nlink, BWP-DownlinkCommon, BWP-DownlinkDedicated, etc.) or broadcast SI (e.g., SIB).

RRC State Transition to Provide UL Feedback

In one embodiment, a UE may perform RRC state transition in order to provide UL feedback in response to a (control information and/or data, e.g., MAC PDU/TB, related to) broadcast/multicast service in the DL.

In one implementation, the RRC state transition may be the transition from the RRC_IDLE state to the RRC_CONNECTED state. Specifically, a UE may initiate an RRC connection re-establishment procedure or a RRC connection setup procedure.

In one implementation, the RRC state transition may be the transition from the RRC_INACTIVE state to the RRC_CONNECTED state. In this implementation, a UE may initiate an RRC connection resume procedure.

In one example, if a UE in the RRC_IDLE state receives a broadcast/multicast service in the DL, and the UE satisfies the condition(s) (as shown above) to perform UL feedback in response to the received broadcast/multicast service, e.g., via MAC CE or HARQ feedback, the UE may perform RRC state transition to the RRC_CONNECTED state. Moreover, the RRC state transition may involve initiation of an RRC connection re-establishment procedure or initiation of an RRC connection setup procedure.

In one example, if a UE in RRC_INACTIVE state receives a broadcast/multicast service in the DL, and the UE satisfies the condition(s) (as shown above) to perform UL feedback in response to the received broadcast/multicast service, e.g., via MAC CE or HARQ feedback, the UE may perform an RRC state transition to the RRC_CONNECTED state. Moreover, the RRC state transition may involve initiation of an RRC connection resume procedure. Moreover, the proposed counter and/or timer (e.g., MBMS_timer and Consecutive_failure_timer) in this example may (or may not) be reset if the UE receives an RRC Connection Setup message in response to an RRC Resume Request message.

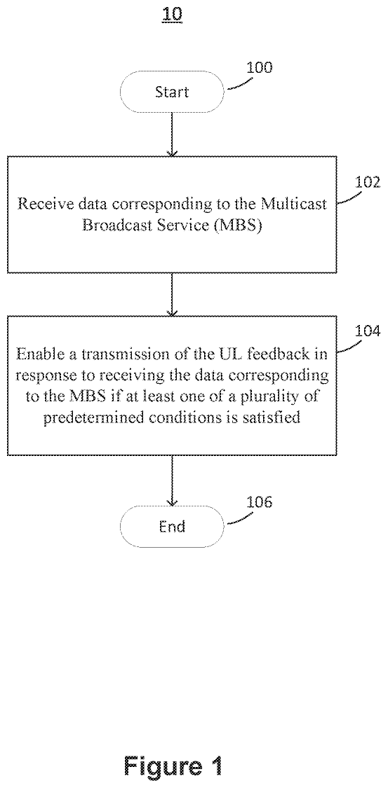

Please refer to FIG. 1, which illustrates a procedure 10 performed by a UE for providing UL feedback in response to receiving MBS data according to an implementation of the present disclosure. As shown in FIG. 1, the procedure 10 for the UE includes the following actions:

Action 100: Start.

Action 102: Receive data corresponding to the MBS.

Action 104: Enable a transmission of the UL feedback in response to receiving the data corresponding to the MBS if at least one of a plurality of predetermined conditions is satisfied.

Action 106: End.

Preferably, action 102 to action 104 of the procedure 10 may be performed by the UE. In some implementation, the UE may receive the data corresponding to the MBS in action 102, where the data is associated with a MAC PDU or a TB for a corresponding HARQ process. In action 104, the UE may enable the transmission of the UL feedback in response to receiving the data if one predetermined condition is satisfied. In one implementation, the plurality of predetermined conditions includes: (1) an indication has been received to enable the UL feedback in response to receiving the data corresponding to the MBS; and (2) a UL resource for transmitting the UL feedback has been indicated. In another implementation, the indication is included in at least one of DCI, a DL MAC CE, a DL dedicated RRC message, and broadcast SI.

Moreover, the procedure 10 may further include the following actions/procedures/mechanisms/operations. In one example, the procedure 10 may further include disabling the transmission of the UL feedback if none of the predetermined conditions is satisfied. In another example, the procedure 10 may further include receiving the data in a frequency range, and enabling the transmission of the UL feedback if the indication enables the UL feedback in response to receiving the data in the frequency range, where the frequency range corresponds to a DL BWP or a frequency supported by a cell. In another example, the procedure 10 may further include, while enabling the transmission of the UL feedback, initiating an RA procedure if the UL resource for transmitting the UL feedback has not been received. In another example, the procedure 10 may further include receiving DCI associated with a G-RNTI for the MBS. Specifically, the DCI indicates a DL resource channel for receiving the data corresponding to the MBS, the indication is transmitted to a group of UEs that are receiving the MBS with the same G-RNTI, and a field of the DCI indicates the UL resource for transmitting the UL feedback.

In some implementations, the UL feedback includes transmitting a HARQ ACK or a HARQ NACK that corresponds to a HARQ process of the data on a PUCCH resource, or the UL feedback includes transmitting at least one of a UL MAC CE and a UL RRC message on a PUS CH resource. Specifically, the HARQ ACK indicates that the data with the HARQ process is successfully received, and the HARQ NACK indicates that the data with the HARQ process is not successfully received. Also, the UL MAC CE or the UL RRC message includes at least one of a first value and a second value, the first value indicates that the data is successfully received, and the second value indicates that the data is not successfully received.

Certainly, the detailed mechanisms and/or operations for the procedure 10 have been described in above implementations/paragraphs and omitted hereinafter for brevity. Certainly, the detailed mechanisms and/or operations for action 102 to action 104 are also omitted hereinafter for brevity.

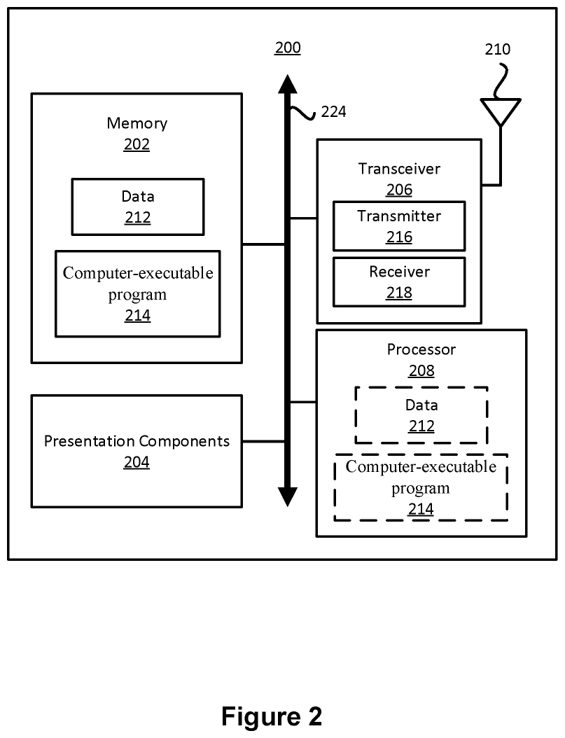

Please refer to FIG. 2, which illustrates a block diagram of a node 200 for wireless communication according to an implementation of the present disclosure. As illustrated in FIG. 2, the node 200 includes a transceiver 206, a processor 208, a memory 202, one or more presentation components 204, and at least one antenna 210. The node 200 may also include a Radio Frequency (RF) spectrum band module, a BS communications module, an NW communications module, and a system communications management module, input/output (I/O) ports, I/O components, and power supply (not explicitly illustrated in FIG. 2). Each of these components may be in communication with each other, directly or indirectly, over one or more buses 224. The node 200 may be a UE or a BS that performs various functions disclosed herein, for example, with reference to FIG. 1.

The transceiver 206 includes a transmitter 216 (e.g., transmitting/transmission circuitry) and a receiver 218 (e.g., receiving/reception circuitry) and may be configured to transmit and/or receive time and/or frequency resource partitioning information. The transceiver 206 may be configured to transmit in different types of subframes and slots, including, but not limited to, usable, non-usable, and flexibly usable subframes and slot formats. The transceiver 206 may be configured to receive data and control channels.

The node 200 may include a variety of computer-readable media. Computer-readable media may be any available media that may be accessed by the node 200 and include both volatile (and non-volatile) media and removable (and non-removable) media. By way of example, and not limitation, computer-readable media may include computer storage media and communication media. Computer storage media may include both volatile (and non-volatile) and removable (and non-removable) media implemented according to any method or technology for storage of information such as computer-readable.

Computer storage media includes RAM, ROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer storage media does not include a propagated data signal. Communication media may typically embody computer-readable instructions, data structures, program modules, or other data in a modulated data signal, such as a carrier wave, or other transport mechanism and include any information delivery media.

The term “modulated data signal” may refer to a signal that has one or more of its characteristics set or changed in such a manner as to encode information in the signal. By way of example, and not limitation, communication media may include wired media such as a wired NW or direct-wired connection, and wireless media such as acoustic, RF, infrared, and other wireless media. Combinations of any of the previous disclosure should also be included within the scope of computer-readable media.

The memory 202 may include computer-storage media in the form of volatile and/or non-volatile memory. The memory 202 may be removable, non-removable, or a combination thereof. For example, the memory 202 may include solid-state memory, hard drives, optical-disc drives, etc.

As illustrated in FIG. 2, the memory 202 may store a computer-executable (or readable) program 214 (e.g., software codes) that is configured to, when executed, cause the processor 208 to perform various functions disclosed herein, for example, with reference to FIG. 1. Alternatively, the computer-executable program 214 may not be directly executable by the processor 208 but may be configured to cause the node 200 (e.g., when compiled and executed) to perform various functions disclosed herein.

The processor 208 (e.g., having processing circuitry) may include an intelligent hardware device, a Central Processing Unit (CPU), a microcontroller, an ASIC, etc. The processor 208 may include memory. The processor 208 may process the data 212 and the computer-executable program 214 received from the memory 202, and information received via the transceiver 206, the baseband communications module, and/or the NW communications module. The processor 208 may also process information to be sent to the transceiver 206 for transmission through the antenna 210 to the NW communications module for subsequent transmission to a CN.

One or more presentation components 204 may present data to a person or other device. Examples of presentation components 204 may include a display device, speaker, printing component, vibrating component, etc.

From the present disclosure, it is manifested that various techniques may be used for implementing the disclosed concepts without departing from the scope of those concepts. Moreover, while the concepts have been disclosed with specific reference to certain implementations, a person of ordinary skill in the art would recognize that changes may be made in form and detail without departing from the scope of those concepts. As such, the disclosed implementations are to be considered in all respects as illustrative and not restrictive. It should also be understood that the present disclosure is not limited to the particular disclosed implementations. Many rearrangements, modifications, and substitutions are possible without departing from the scope of the present disclosure.

1. A wireless communication method performed by a User Equipment (UE) for providing uplink (UL) feedback in response to receiving data corresponding to a Multicast Broadcast Service (MBS), the wireless communication method comprising:
receiving the data corresponding to the MBS; and
enabling a transmission of the UL feedback in response to receiving the data corresponding to the MBS if at least one of a plurality of predetermined conditions is satisfied, the plurality of predetermined conditions comprising:
receiving an indication to enable the UL feedback in response to receiving the data corresponding to the MBS; and
receiving an indication of a UL resource for transmitting the UL feedback.

2. The wireless communication method according to claim 1, further comprising:
disabling the transmission of the UL feedback if none of the plurality of predetermined conditions is satisfied.

3. The wireless communication method according to claim 1, wherein the indication to enable the UL feedback is included in at least one of Downlink Control Information (DCI), a downlink (DL) Medium Access Control (MAC) Control Element (CE), a DL dedicated Radio Resource Control (RRC) message, and broadcast system information.

4. The wireless communication method according to claim 1, further comprising:
receiving the data corresponding to the MBS within a frequency range; and
enabling the transmission of the UL feedback if the indication to enable the UL feedback is received in response to receiving the data corresponding to the MBS within the frequency range.

5. The wireless communication method according to claim 4, wherein the frequency range corresponds to a DL Bandwidth Part (BWP) or a frequency supported by a cell.

6. The wireless communication method according to claim 1, further comprising transmitting the UL feedback after enabling transmission of the UL feedback, wherein:
transmitting the UL feedback includes:
transmitting a Hybrid Automatic Repeat Request (HARQ) Acknowledge (ACK) or a HARQ Negative ACK (NACK) that corresponds to a HARQ process of the data corresponding to the MBS on a Physical Uplink Control Channel (PUCCH) resource, or
transmitting at least one of a UL Medium Access Control (MAC) Control Element (CE) or a UL Radio Resource Control (RRC) message on a Physical Uplink Shared Channel (PUSCH) resource;
the HARQ ACK indicates that the data with the HARQ process is successfully received and the HARQ NACK indicates that the data with the HARQ process is not successfully received; and
the UL MAC CE or the UL RRC message includes at least one of a first value or a second value, the first value indicates that the data is successfully received, and the second value indicates that the data is not successfully received.

7. The wireless communication method according to claim 1, further comprising:
while enabling the transmission of the UL feedback, initiating a Random Access (RA) procedure if the UL resource for transmitting the UL feedback has not been indicated.

8. The wireless communication method according to claim 1, further comprising:
receiving Downlink Control Information (DCI) associated with a Group Radio Network Temporary Identifier (G-RNTI) for the MBS, wherein the DCI indicates a downlink (DL) resource channel for receiving the data corresponding to the MBS.

9. The wireless communication method according to claim 8, wherein the indication to enable the UL feedback is transmitted to a group of UEs that are receiving the data corresponding to the MBS with a same G-RNTI, and a field of the DCI indicates the UL resource for transmitting the UL feedback.

10. The wireless communication method according to claim 1, wherein the data corresponding to the MBS is associated with a Medium Access Control (MAC) Protocol Data Unit (PDU) or a Transport Block (TB) for a corresponding Hybrid Automatic Repeat Request (HARD) process.

11. A User Equipment (UE) in a wireless communication system for providing uplink (UL) feedback in response to receiving data corresponding to a Multicast Broadcast Service (MBS), the UE comprising:
at least one processor; and
at least one memory coupled to the at least one processor, wherein the at least one memory stores computer-executable instructions that, when executed by the at least one processor, cause the UE to:
receive the data corresponding to the MBS; and
enable a transmission of the UL feedback in response to receiving the data corresponding to the MBS if at least one of a plurality of predetermined conditions is satisfied,. the plurality of predetermined conditions comprising:
receiving an indication to enable the UL feedback in response to receiving the data corresponding to the MBS; and
receiving an indication of a UL resource for transmitting the UL feedback.

12. The UE according to claim 11, wherein the computer-executable instructions, when executed by the at least one processor, further cause the UE to:
disable the transmission of the UL feedback if none of the plurality of predetermined conditions is satisfied.

13. The UE according to claim 11, wherein the indication to enable the UL feedback is included in at least one of Downlink Control Information (DCI), a downlink (DL) Medium Access Control (MAC) Control Element (CE), a DL dedicated Radio Resource Control (RRC) message, and broadcast system information.

14. The UE according to claim 11, wherein the computer-executable instructions, when executed by the at least one processor, further cause the processor UE to:
receive the data corresponding to the MBS within a frequency range; and
enable the transmission of the UL feedback if the indication to enable the UL feedback is received in response to receiving the data corresponding to the MBS within the frequency range.

15. The UE according to claim 14, wherein the frequency range corresponds to a DL Bandwidth Part (BWP) or a frequency supported by a cell.

16. The UE according to claim 11, wherein:
the computer-executable instructions, when executed by the at least one processor, further cause the UE to transmit the UL feedback after enabling transmission of the UL feedback;
transmitting the UL feedback includes:
transmitting a Hybrid Automatic Repeat Request (HARQ) Acknowledge (ACK) or a HARQ Negative ACK (NACK) that corresponds to a HARQ process of the data corresponding to the MBS on a Physical Uplink Control Channel (PUCCH) resource, or
transmitting at least one of a UL Medium Access Control (MAC) Control Element (CE) or a UL Radio Resource Control (RRC) message on a Physical Uplink Shared Channel (PUSCH) resource;
the HARQ ACK indicates that the data with the HARQ process is successfully received and the HARQ NACK indicates that the data with the HARQ process is not successfully received; and
the UL MAC CE or the UL RRC message includes at least one of a first value or a second value, the first value indicates that the data is successfully received, and the second value indicates that the data is not successfully received.

17. The UE according to claim 11, wherein the computer-executable instructions, when executed by the at least one processor, further cause the UE to:
while enabling the transmission of the UL feedback, initiate a Random Access (RA) procedure if the UL resource for transmitting the UL feedback has not been received.

18. The UE according to claim 11, wherein the computer-executable instructions, when executed by the at least one processor, further cause the UE to:
receive Downlink Control Information (DCI) associated with a Group Radio Network Temporary Identifier (G-RNTI) for the MBS, wherein the DCI indicates a downlink (DL) resource channel for receiving the data corresponding to the MBS.

19. The UE according to claim 18, wherein the indication to enable the UL feedback is transmitted to a group of UEs that are receiving the data corresponding to the MBS with a same G-RNTI, and a field of the DCI indicates the UL resource for transmitting the UL feedback.

20. The UE according to claim 11, wherein the data corresponding to the MBS is associated with a Medium Access Control (MAC) Protocol Data Unit (PDU) or a Transport Block (TB) for a corresponding Hybrid Automatic Repeat Request (HARD) process.
